(19) United States
(12) Patent Application Publication
(10) Pub. No.: US 2016/0125748 A1
(43) Pub. Date: May 5, 2016

(54) Memory test for Alzheimer's disease

(71) Applicant: John Wesson Ashford, Redwood City, CA (US)

(72) Inventor: John Wesson Ashford, Redwood City, CA (US)

(21) Appl. No.: 14/532,100

(22) Filed: Nov. 4, 2014

(51) Int. Cl. G09B 5/00

(52) U.S. Cl. CPC G09B 5/00

(57) ABSTRACT

A method for assessing cognitive function in a subject uses a computer having a display, a response sensor and a microprocessor and includes the step of using the display to present to the subject a plurality of items to be analyzed by the subject. The items presented to the subject are intermixed with other of the items being tested for recognition. The method also includes the step of having the subject activate the response sensor after the subject has looked at the display and has recognized the presented items from memory. The subject is tested to determine if the subject recognizes each of the items as meeting a specific criterion. The method further includes the step of using the microprocessor to determine the subject's accuracy and his response speed to each of the recognized items. The response speed for each of the recognized items is the time required between when the subject is shown an item and when the subject correctly responds that he recognizes the item.

The application is a continuation-in-part of the provisional application filed under Ser. No. 12/931,919 on Feb. 14, 2010 which is a continuation-in-part of the provisional application filed under Ser. No. 61/339,663 on Mar. 1, 2009.

### BACKGROUND OF THE INVENTION

1. Field of the Invention

The present invention relates generally to a system and a method for computer-based cognitive performance testing.

2. Description of the Prior Art

It is estimated that, over the next twenty years, one in every five persons will be over the age of 65. With this new demographic profile will come an increase in a wide variety of age-related conditions including dementia and Alzheimer's disease. Dementia is a syndrome of progressive decline, in multiple domains of cognitive function that eventually leads to an inability to maintain normal social and/or occupational performance. Alzheimer's disease is the most common type of dementia, afflicting approximately 4 million Americans. One in ten persons over the age of 65 and nearly half of those over the age of 85 suffer from Alzheimer's disease. Alzheimer's disease is the fourth leading cause of death in the U.S. The cost to American society is estimated to be at least $100 billion every year making Alzheimer's disease the third most costly disorder of aging. Early identification is critical in progressive conditions such as Alzheimer's disease because earlier treatment may be more effective than later treatment in preserving cognitive function. Early detection may allow time to explore options for treatment and care. Early detection is compromised by the failure of many patients to report to their treating physicians such early symptoms of Alzheimer's disease as memory lapses and mild, but progressive, deterioration of specific cognitive functions, e.g., language (aphasia), motor skills (apraxia), and perception (agnosia). Studies have documented the difficulty experienced by even well-trained health care professionals in correctly diagnosing Alzheimer's disease and other forms of dementia. A simple, sensitive, reliable, and easily-administered Alzheimer's disease diagnostic test would be of great assistance in targeting individuals for early intervention. The earliest manifestation of Alzheimer's disease is often memory impairment which is a requirement in each of the two sets of criteria for diagnosis of dementia that are commonly used—the National Institute of Neurological and Communicative Disorders and Stroke/Alzheimer's Disease and Related Disorders Association (NINCDS/ADRDA) criteria, which are specific for Alzheimer's disease and the American Psychiatric Association's Diagnostic and Statistical Manual of Mental Disorders, Fourth Edition (DSM-IV) criteria, which are applicable for all forms of dementia. Any test for either Alzheimer's disease or dementia associated with memory impairment should be most sensitive for the early detection of memory impairment.

Conventional memory tests are not optimal for the detection of mild dementia or the early stages of Alzheimer's disease. Some of these tests are inappropriately sensitive to the patient's educational level (White and Davis, Journal of General Internal Medicine, Volume 5, pages 438-445, 1990: McDowell and Kristjansson, Mental Status Testing, in Measuring Health: a guide to rating scales and questionnaires, 1996:287 334). These tests may fail to test for certain types of memory loss that are typical of either early dementia or Alzheimer's disease and fail to reflect whether compounds or therapy administered to treat dementia are having the desired effect. These tests often suffer from a high rate of false negatives (low sensitivity) or false positives (low specificity). Despite the use of existing memory tests the problem still to be solved is to identify people who are at an early stage of developing cognitive impairment. The generally accepted standard way to identify memory impairment is by low performance (recall, recognition and reproduction) on currently available memory tests according to normative data. If low performance is the criterion for memory impairment then memory impairment can only be identified when memory performance is low, necessarily making it impossible to identify less severe earlier memory impairment. Earlier detection of cognitive impairment would permit treatment to be started at an earlier stage than is now possible. Earlier treatment may be more effective than later treatment in preserving cognitive function or in preventing further deterioration of cognitive function. Memory impairment is the earliest and most prominent sign of Alzheimer's disease. Alzheimer's disease has a very long course. Declining memory can remain within the normal range for many years. Earlier detection of memory impairment is important for earlier detection of Alzheimer's disease. A new paradigm for assessing memory and detecting memory impairment is needed. Specifically one that can detect evidence of memory impairment when declining memory is still within normal limits.

US Patent Application No. 2011/0236864 teaches a method for assessing memory in a subject which includes the steps of presenting to the subject a list of items to be retrieved from memory by the subject, having the subject recognize the presented items from memory, determining the subject's response speed to each of the recognized repeated items and analyzing a plurality of the response speeds for the recognized repeated items. The items which are presented to the subject are intermixed with repetitions of the items being tested for recognition. The subject is tested to determine if he recognizes each repeated item as being a repeated item. The response speed for each recognized repeated item is the time required between when the subject is shown a repeated item and when the subject responds that he recognizes it as a repeated item. US Patent Application No. 2011/0236864 also teaches the problems of dementia in the world, the difficulties with tests which measure dementia and a specific test.

U.S. Pat. No. 8,794,976 teaches a method which evaluates reaction time data obtained from a stimulus-response testing system. The method includes the step of obtaining reaction time data. The reaction time data is a plurality of reaction times. Each reaction time is an estimate of a time required for a subject to respond to a corresponding stimulus event. The method also includes the step of assigning a weight to each reaction time in the reaction time data in accordance with a weighting function. The weighting function is a rule that defines a mapping between reaction times and corresponding weights. The method further includes the step of determining a weighted reaction time metric based at least in part on a sum of the weights assigned to the reaction times in the reaction time data. Stimulus-response tests conducted on human or other animal subjects involve the presentation of stimulus events to the subject and measuring and/or recording characteristics of the stimulus and/or the subject's response. Stimulus-response tests may also involve analysis of the measured and/or recorded characteristics. Reaction-time tests represent a particular example of a stimulus-response test in which time delay between the stimulus event and the subject response is of particular interest. Reaction time tests represent a common assessment technique for evaluating human cognitive and neuro-behavioral performance. Generally, reaction time tests involve the steps of presenting a stimulus event to the subject, assessing and/or recording the time at which the stimulus event is presented and assessing and/or recording the time at which the subject responds to the stimulus. Stimulus-response tests (including reaction time tests) may be delivered on a wide-variety of hardware and software platforms. Stimulus-response tests may be administered on personal computers which include relatively common stimulus output devices (e.g. monitors, displays and speakers) and relatively common response input devices (e.g. keyboards, computer mice, joysticks and buttons). Stimulus-response tests can be administered by dedicated hardware devices with particular stimulus output devices and corresponding response input devices. There is a general desire to provide systems and methods for accurately analyzing the data obtained from reaction time tests.

U.S. Pat. No. 8,475,171 teaches a method which measures cognitive ability and/or detects cognitive impairment or decline. The methods can be used to either diagnose or test susceptibility to cognitive impairments in children or in elderly people such as cognitive impairments associated with Alzheimer's disease. These methods also can be used to evaluate treatment effects and/or measure cognitive decline over time. Many environmental and intrinsic factors influence cognitive function. Intrinsic factors that can influence cognitive function include sex, age and genetic makeup.

Referring to FIG. 1 of U.S. Pat. No. 8,475,171 a computing environment 100 includes at least one processing unit 110 and memory 120. The most basic configuration 130 is included within a dashed line. The processing unit 110 executes computer-executable instructions and may be a real or a virtual processor. In a multi-processing system, multiple processing units execute computer-executable instructions to increase processing power. The memory 120 may be volatile memory including registers, cache, RAM, non-volatile memory such as ROM, EEPROM, flash memory or some combination of the two. The memory 120 stores software 180 implementing one or more of the described techniques and tools for testing cognitive ability and/or cognitive impairment. A computing environment may have additional features. The computing environment 100 includes storage 140, one or more input devices 150, one or more output devices 160, and one or more communication connections 170. There is an interconnection mechanism (not shown such as a bus, controller or network interconnects the components of the computing environment 100. Operating system software (not shown provides an operating environment for other software executing in the computing environment 100 and coordinates activities of the components of the computing environment 100. The storage 140 may be removable or non-removable, and includes magnetic disks, magnetic tapes or cassettes, CD-ROMs, DVDs, flash memory, or any other medium which can be used to store information and which can be accessed within the computing environment 100. The storage 140 stores instructions for the software 180. The input device 150 may be a touch input device such as a keyboard, mouse, pen, touch screen, or trackball, a voice input device, a scanning device, or another device that provides input to the computing environment 100. For audio or video encoding the input devices 150 may be a sound card, video card, TV tuner card, or similar device that accepts audio or video input in analog or digital form, or a CD-ROM, CD-RW or DVD that reads audio or video samples into the computing environment 100. The output device(s 160 may be a display, printer, speaker, CD- or DVD-writer, or another device that provides output from the computing environment 100. The communication connection 170 enables communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. Communication media include wired or wireless techniques implemented with an electrical, optical, RF, infrared, acoustic, or other carrier. The techniques and tools can be described in the general context of computer-readable media. Computer-readable media are any available media that can be accessed within a computing environment. With the computing environment 100, computer-readable media include memory 120, storage 140, communication media, and combinations of any of the above. The techniques and tools can be described in the general context of computer-executable instructions, such as those included in program modules, being executed in a computing environment on one or more target real processors or virtual processors. Generally, program modules include routines, programs, libraries, objects, classes, components and data structures that perform particular tasks or implement particular abstract data types. The functionality of the program modules may be combined or split between program modules as desired in various embodiments. Computer-executable instructions for program modules may be executed within a local or distributed computing environment.

Referring to FIG. 2 in conjunction with FIG. 1 of U.S. Pat. No. 8,475,171 there is a generalized technique 200 for analysis of cognitive status of a user using testing with a virtual reality (“VR” environment). A software tool such as one operating in the computer system environment or other tool performs the technique 200. The tool receives input 210 from the user as the user interacts with software presenting a VR environment. The VR environment includes a first-person, three-dimensional graphical rendering of the environment as well as sound cues for the environment. The environment is graphically rendered on a computer monitor or, for a more immersive experience, presented to the user using virtual reality goggles or another head mounted display. Inputs such as direction of movement, speed of movement are received from the user using a force-feedback joystick, other joystick, mouse, keyboard or other input device.

The tool 200 measures the performance 220 of the user in the VR environment. The performance is based at least in part upon the received input. The organization of the VR environment depends on implementation but includes areas such as quadrants which may be organized in terms of a coordinate space. As an intermediate part of measuring performance the tool tracks position of the user over time in the coordinate space. The results of the tracking are stored in memory or a file as time-stamped coordinate locations for later analysis of patterns of user behavior. In terms of metrics, the tool measures one or more of the following: cumulative distance or start to target traversed in the VR environment, time elapsed before reaching either a target or targets in the VR environment, percentage of successful trials where success is finding a target, time spent in a target area of the VR environment, velocity of movement in the VR environment, pattern of movement between multiple areas or in terms of coordinates in the VR environment and/or pattern of time spent in respective areas of the VR environment.

The tool 200 also measures performance using other and/or additional metrics. Some metrics such as velocity of movement and time elapsed before reaching a target may depend on each other to some extent, while other metrics do not. The tool measures performance in a series of VR tests, with some tests having one or more “visible” targets and other tests having one or more “hidden” targets. In the “visible” target trials, one or more visual or audible cues assist the user in finding a target. A prominent flag or other graphical cue is placed next to the target to help the user find the target, or directional arrows guide the user to the target. In the hidden target trials, the performance of the user in finding the target(s is measured without giving the user the cues from the visible target testing. Such tests help measure memory retention of the user in navigating the VR environment. The tool 200 uses the measured performance 230 of the user in the VR environment in analysis of cognitive status. The tool 200 assesses: (a the presence or extent of age-related cognitive decline (e.g., a decline in memory performance or learning performance, (b presence or extent of pediatric cognitive disability such as a memory performance problem or learning performance problem, (c presence or extent of progression of Alzheimer's disease, (d presence of a characteristic of preclinical Alzheimer's disease, and/or (e response of the user to therapeutic intervention to treat cognitive decline. To make the assessment, the tool can use artificial intelligence mechanisms such as classifiers such as neural networks for pattern recognition and statistical analysis. The tool may use the measured performance for a different type of analysis. The cognitive status assessment relates the measured performance to a cognitive status classification. In making the assessment, the tool can compensate for the effects of sex, age and/or learning about the VR environment (e.g., navigation skills, landscape on the measured performance. The user repeatedly takes the VR navigation test and the performance of the user over time is measured so as to assess changes in cognitive status of the user. This involves comparing cognitive status assessments from trial to trial for the user. The results of testing may be compared for multiple users as part of population studies for the efficacy of a therapy.

U.S. Pat. No. 7,314,444 teaches a method which assesses either episodic memory or semantic memory in a subject. The method screens for an agent directed to treating, slowing down the progress of, attenuating the symptoms of, or preventing dementia characterized by episodic memory impairment. The method screens for an agent directed to treating, slowing down the progress of, attenuating the symptoms of, or preventing dementia characterized by semantic memory impairment. The method measures semantic memory in a subject.

U.S. Pat. No. 6,964,638 teaches a method which measures the cognitive performance of an individual. The individual completes at least one cognitive test with at least one testing protocol. The result of at least one cognitive test is stored in a computer readable media. A reliable change technique is applied to calculate a reliable change measure. The reliable change measure is a statistically meaningful inference of a neurological pathology. The reliable change technique uses at least one baseline of the individual.

U.S. Pat. No. 5,715,451 teaches a system which constructs formulae for processing medical data. Rather than providing a prepared statistical analysis package a computer interface constructs statistical and other mathematical formulae to ease the analysis of clinical data.

U.S. Pat. No. 5,778,882 teaches a health monitoring system that tracks the state of health of a patient and compiles a chronological health history. Not disclosed in the above-cited prior art is a non-invasive, computerized system to accurately measure cognitive function and changes in cognitive function over time. There is a need for such an invention that is easy to administer, rapid, less expensive and accurate enough to enable assessment of the cognitive impairment impact of a wide variety of agents or environments.

U.S. Pat. No. 6,306,086 teaches memory tests using item-specific weighted memory measurements and uses thereof which increase the usefulness, sensitivity and specificity of tests that measure memory and facets of memory, including learning, retention, recall and/or recognition.

Ashford first described these issues for studying items and applying item analysis to Alzheimer's disease and dementia in 1989. See Ashford J W, Kolm P, Colliver J A, Bekian C, Hsu L N. Alzheimer patient evaluation and the mini-mental state: item characteristic curve analysis, Journal of Gerontology 1989 September, Volume 44(5), pages 139-46. See also http://www.medafile.com/jwa/JWA1989.pdf. Another useful citation for the need to screen for Alzheimer's disease is Ashford J W, Borson S, O'Hara R, Dash P, Frank L, Robert P, Shankle W R, Tierney M C, Brodaty H, Schmitt F A, Kraemer H C, Buschke H. Fillit H, “Should older adults be screened for dementia? It is important to screen for evidence of dementia,” Alzheimer's & Dementia (2007) April, volume 3, pages 75-80. See also http://www.medafile.com/jwa/JWAA&D07.pdf. A good review of tests to screen to memory problems, dementia and Alzheimer's disease is Ashford J W, “Screening for Memory Disorder, Dementia, and Alzheimer's disease,” Aging Health (2008), Volume 4(4), pages 399-432. See also http://www.medafile.com/jwa/Ashford_AH08.pdf. Specifically the sensitivity and specificity of such tests are enhanced by selectively weighting the value of specific items recalled by the test subject either by weighting such items within any specific testing trial or across numerous testing trials. Also disclosed are various methods of reducing ceiling effects in memory tests. The tests employ item-specific weighting for the diagnosis of Alzheimer's Disease and other dementia characterized by memory impairment, as well as a method of screening for and evaluating the efficacy of potential therapeutics directed to the treatment of such dementia.

This method increases the usefulness, sensitivity and specificity of tests that measure memory and facets of memory, including learning, retention, recall and/or recognition. There are various methods of reducing ceiling effects in memory tests and improved tests which employ item-specific weighting for the diagnosis of Alzheimer's Disease and other dementia characterized by memory impairment, as well as a method of screening for and evaluating the efficacy of potential therapeutics directed to the treatment of such dementia.

U.S. Pat. No. 5,059,127 teaches a computerized mastery testing system which provides for the computerized implementation of sequential testing without regard to the speed and accuracy of the individual examinee keystroke responses to the test stimuli.

s U.S. Pat. No. 5,657,256 teaches a method for incorporating into the construction of adaptive tests expert test development practices. The method is an application of a weighted deviations—model and a heuristic for automated item selection. Taken into account is the number and complexity of constraints on item selection found in expert test development practice. The method of the present invention incorporates content, overlap, and set constraints on the sequential selection of items as desired properties of the resultant adaptive tests, rather than as strict requirements. Aggregate failures are minimized in the same fashion as in the construction of conventional tests. The extent to which restrictions on item selection are not satisfied is then the result of deficiencies in the item pool, as it is with conventional tests. Conventional multiple-choice tests, which are administered to large numbers of examinees simultaneously by using paper-and-pencil, have been commonly used for educational testing and measurement for many years. Such tests are typically given under standardized conditions, where every examinee takes the same or a parallel test form. This testing strategy represents vastly reduced unit costs over the tests administered individually by examiners that existed during the early part of the last century.

There remains great interest in restoring some of the advantages of individualized testing. William Turnbull suggested investigations in this direction in 1951 and coined the phrase “tailored testing” to describe this possible paradigm (Lord, 1980, p. 151). Possibilities for constructing individualized tests became likely with the advent of Item Response Theory (IRT) (Lord, 1952, 1980) as a psychometric foundation. Beginning in the 1960's, Lord (1970, 1971a) began to explore this application of IRT by investigating various item selection strategies borrowed from the bioassay field. Later work by Lord (1977, 1980) and Weiss (1976, 1978) laid the foundation for the application of adaptive testing as an alternative to conventional testing. Adaptive tests are tests in which items are selected to be appropriate for the examinee; the test adapts to the examinee. All but a few proposed designs, including Lord's flexi-level test, have assumed that items would be chosen and administered to examinees on a computer, thus the term computerized adaptive testing, or CAT. Adaptive testing which uses multiple-choice items has received increasing attention as a practical alternative to paper-and-pencil tests as the cost of modern low-cost computing technology has declined. The Department of Defense has seriously considered its introduction for the Armed Services Vocational Aptitude Battery (CAT-ASVAB) (Wainer, et al., 1990); large testing organizations have explored and implemented CAT. The Educational Testing Service and the College Entrance Examination Board for the College Placement Tests (CPTs) program (College Board, 1990) have implemented adaptive testing. Certification and licensure organizations are paying increased attention to adaptive testing as a viable alternative (Zara, 1990). Conventional test construction—the construction of multiple-choice tests for paper-and-pencil administration—is time consuming and expensive. Aside from the costs of writing and editing items, items must be assembled into test forms. In typical contexts found in public and private testing organizations, a goal is to construct the most efficient test possible for some measurement purpose. This requires that item selection be subject to various rules that govern whether or not an item may be included in a test form. Such rules are frequently called test specifications and constitute a set of constraints on the selection of items. These constraints can be considered as falling into four separate categories: (1) constraints that focus on some intrinsic property of an item, (2) constraints that focus on item features in relation to all other candidate items, (3) constraints that focus on item features in relation to a subset of all other candidate items, and (4) constraints on the statistical properties of items as derived from pretesting. Tests built for a specific measurement purpose typically have explicit constraints on item content. The test specifications for a test in mathematics may specify the number or percentage of items on arithmetic, algebra and geometry. These specifications may be further elaborated by a specification that a certain percentage of arithmetic items involve operations with whole numbers a certain percentage involve fractions and a certain percentage involve decimals. Likewise, a percentage might be specified for algebra items involving real numbers as opposed to symbolic representations of numbers, and so forth. It is not unusual for fairly extensive test specifications to identify numerous content categories and subcategories of items and their required percentages or numbers. In addition to constraints explicitly addressing item content, constraints are typically given for other features intrinsic to an item that are not directly content related. For example, restrictions may be placed on the percentage of sentence completion items that contain one blank as opposed to two blanks, and two blanks as opposed to three blanks. These types of constraints treat the item type or the appearance of the item to the examinee. A second type of constraint not directly related to content may address the reference of the item to certain groups in the population at large, as when, for example, an item with science content has an incidental reference to a minority or female scientist. Such constraints may also seek to minimize or remove the use of items that contain incidental references that might appear to favor social class or wealth items dealing with country clubs, golf and polo. These types of constraints are frequently referred to as sensitivity constraints and test specifications frequently are designed to provide a balance of such references, or perhaps an exclusion of such references, in the interest of test fairness. In addition to these more formal constraints on various features of items, there are frequently other less formal constraints that have developed as part of general good test construction practices for tests of this type. These constraints may seek to make sure that the location of the correct answer appears in random (or nearly random) locations throughout a test, may seek to encourage variety in items by restricting the contribution of items written by one item writer, and so forth. It is evident that a test must not include an item that reveals the answer to another item. Wainer and Kiley (1987) describe this as cross-information. Kingsbury and Zara (1991) also describe this kind of constraint. In addition to giving direct information about the correct answer to another item, an item can overlap with other items in more subtle ways. Items may test the same or nearly the same point, but appear to be different, as in an item dealing with the sine of 90 degrees and the sine of 45 degrees. If the point being tested is sufficiently similar, then one item is redundant and should not be included in the test because it provides no additional information about the examinee. Items may also overlap with each other in features that are incidental to the purpose of the item. Two reading comprehension passages may both be about science and both may contain incidental references to female minority scientists. It is unlikely that test specialists would seek to include both passages in a general test of reading comprehension. Items that give away answers to other items, items that test the same point as others and items that have similar incidental features as exhibiting content overlap must be constrained by the test specifications. Test specialists who construct verbal tests or test sections involving discrete verbal items, that is, items that are not associated with a reading passage, are concerned that test specifications control a second kind of overlap, here referred to as word overlap. The concern is that relatively uncommon words used in any of the incorrect answer choices should not appear more than once in a test or test section. To do so is to doubly disadvantage those examinees with more limited vocabularies in a manner that is extraneous to the purposes of the test. An incorrect answer choice for a synonym item may be the word “hegira.” Test specialists would not want the word “hegira” to then appear in an incorrect answer choice for a verbal analogy item to be included in the same test.

Some items are related to each other through their relationship to common stimulus material. This occurs when a number of items are based on a common reading passage in a verbal test, or when a number of items are based on a common graph or table or figure in a mathematics test. If test specifications dictate the inclusion of the common stimulus material, then some set of items associated with that material is also included in the test. It may be that there are more items available in a set than need to be included in the test, in which case the test specifications dictate that some subset of the available items be included that best satisfy other constraints or test specifications. Some items are related to each other not through common stimulus material, but rather through some other feature such as having common directions. A verbal test might include synonyms and antonyms, and it might be confusing to examinees if such items were intermixed. Test specifications typically constrain item ordering so that items with the same directions appear together. Whether items form groups based on common stimulus material or common directions or some other feature, we will describe these groups as item sets with the intended implication that items belonging to a set may not be intermixed with other items not belonging to the same set. Information about the statistical behavior of items may be available from the pretesting of items, that is, the administration of these items to examinees who are similar to the target group of examinees. Test specifications typically constrain the selection of items based on their statistical behavior in order to construct test forms that have the desired measurement properties. If the goal of the measurement is to create parallel editions of the same test, these desired measurement properties are usually specified in terms of the measurement properties of previous test editions. If the goal of the measurement is to create a new test for the awarding of a scholarship or to assess basic skills, test specifications will constrain the selection of items to hard items or easy items respectively. These constraints typically take the form of specifying some target aggregation of statistical properties where the statistical properties may be based on conventional difficulty and discrimination or the counterpart characteristics of items found in IRT. If IRT item characteristics are employed, the target might be some combination of item characteristics, as for example, target test information functions. If conventional item statistics are used, the target aggregation is usually specified in terms of frequency distributions of item difficulties and discriminations. Early Monte Carlo investigations of adaptive testing algorithms concentrated predominantly on the psychometric aspects of test construction see Lord, 1970, 1971 a, 1971b). Such investigations eventually led to IRT-based algorithms that were fast, efficient, and psychometrically sound. A review of the most frequently used algorithms is given in Wainer, et al. (1990, Chapter 5) and Lord (1980, Chapter 9). The fundamental philosophy underlying these algorithms of the prior art is as follows:

An initial item is chosen on some basis and administered to the examinee.

Based on the examinee's response to the first item, a second item is chosen and administered. Based on the examinee's response to the first two items, a third item is chosen and administered, etc. In typical paradigms, the examinee's responses to previous items are reflected in an estimate of proficiency that is updated after each new item response is made.

The selection of items continues, with the proficiency estimate updated after each item response, until some stopping criterion is met.

The examinee's final score is the proficiency estimate after all items are administered.

When practical implementation became a possibility, if not yet a reality, researchers began to address the incorporation of good test construction practices as well as psychometric considerations into the selection of items in adaptive testing. One of the first to do so was Lord (1977) in his Broad Range Tailored Test of Verbal Ability. The item pool for this adaptive test consisted of five different types of discrete verbal items. For purposes of comparability or parallelism of adaptive tests, some mechanism is necessary to prevent one examinee's adaptive test from containing items of only one type and another examinee's test containing only items of a different type. To exert this control, the sequence of item types is specified in advance. The first item administered must be of type A, the second through fifth items must be of type B and so forth. In this maximum-likelihood-based adaptive test, Lord selects items for administration based on maximum item information for items of the appropriate pre-specified type in the sequence at an examinee's estimated level of ability. In an attempt to control more item features, the approach of specifying the sequence of item types in advance can become much more elaborate, as in the CPTs where the number of item types may range from one to fifty.

In this context, items are classified as to type predominantly on the basis of intrinsic item features discussed previously. The same kind of control is used in the CAT-ASVAB. This type of content control has been called a constrained CAT (C-CAT) by Kingsbury and Zara (1989). A major disadvantage of this approach of the prior art is that it assumes that item features of interest partition the available item pool into mutually exclusive subsets. Given the number of intrinsic item features that may be of interest to test specialists, the number of mutually exclusive partitions can be very large and the number of items in each partition can become quite small. Consider items that can be classified with respect to only 10 different item properties. Each property has only two levels. The number of mutually exclusive partitions of such items is 2.sup.10-1, or over 1000 partitions. Even with a large item pool, the number of items in each mutually exclusive partition can become quite small. Nevertheless, such an approach would be possible except for the fact that no effort is made with this type of control to incorporate considerations of overlap or sets of items. These considerations could in theory be accomplished by further partitioning by overlap group and by set, but the number of partitions would then become enormous. Wainer and Kiely (1987) and Wainer (1990) hypothesize that the use of testlets can overcome these problems. Wainer and Kiely define a test-let as a group of items related to a single content area that is developed as a unit and contains a fixed number of predetermined paths that an examinee may follow (1987, p. 190). They suggest that an adaptive test can be constructed from test-lets by using the test-let rather than an item as the branching point. Because the number of paths through a fairly small pool of test-lets is relatively small, they further suggest that test specialists could examine all possible paths. They hypothesize that this would enable test specialists to enforce constraints on intrinsic item features, overlap and item sets in the same manner as is currently done with conventional tests. Kingsbury and Zara (1991) investigated the measurement efficiency of the test-let approach to adaptive testing as compared to the C-CAT approach. Their results show that the test-let approach could require from 4 to 10 times the test length of the C-CAT approach to achieve the same level of precision. Aside from measurement concerns, the test-let approach rests on the idea that the pool of available items can be easily subdivided into mutually exclusive subsets (test-lets), also a disadvantage of the C-CAT approach. The test-let approach addresses overlap concerns within a test-let because the number of items in a test-let is small. It prevents overlap across test-lets through the mechanism of a manual examination of the paths through the test-let pool. If the number of paths is large, this approach becomes difficult to implement. A distinct advantage of the test-let approach over the C-CAT approach is the facility to impose constraints on the selection of sets of items related through common stimulus material or some other common feature. A single reading comprehension passage and its associated items could be defined as a test-let, for example, as long as the items to be chosen for that passage are fixed in advance as part of the test-let construction effort. The C-CAT approach cannot be easily modified to handle this type of constraint. Unlike prior methods of adaptive testing, the present invention is based on a mathematical model formatted as a binary programming model. All of the test specifications discussed above can be conveniently expressed mathematically as linear constraints, in the tradition of linear programming. A specification such as “select at least two but no more than 5 geometry items” takes the form where x is the number of selected items having the property “geometry.” Conformance to a specified frequency distribution of item difficulties takes the form of upper and lower bounds on the number of selected items falling into each specified item difficulty range. Similarly, conformance to a target test information function takes the form of upper and lower bounds on the sum of the individual item information functions at selected ability levels. This is based on the premise that it is adequate to consider the test information function at discrete ability levels. This is a reasonable assumption given that test information functions are typically relatively smooth and that ability levels can be chosen to be arbitrarily close to each other (van der Linden, 1987). A typical formulation of a binary programming model has the following mathematical form. Let i=1, . . . , N index the items in the pool, and let x.sub.i denote the decision variable that determines whether item i is included in (x.sub.i=1) or excluded from (x.sub.i=0) the test. Let j=1, . . . , J index the item properties associated with the non-psychometric constraints, let L.sub.j and U.sub.j be the lower and upper bounds (which may be equal) respectively on the number of items in the test having each property, and let a.sub.ij be 1 if item i has property j and 0 if it does not. Then the model for a test of fixed length n is specified as: ##EQU1## Note that equation (2) fixes the test length, while equations (3) and (4) express the non-psychometric constraints as lower and upper bounds on the number of items in the test with the specified properties. The objective function, z, can take on several possible forms (see van der Linden and Boekkooi-Timminga, 1989, table 3). It typically maximizes conformance to the psychometric constraints. Examples include maximizing absolute test information; minimizing the sum of the positive deviations from the target test information; or minimizing the largest positive deviation from the target. Models that minimize the maximum deviation from an absolute or relative target are referred to as “minimax” models. The objective function can also take the form of minimizing test length, as in Theunissen (1985), or minimizing other characteristics of the test, such as administration time, frequency of item administration, and so forth. Finally, z could be a dummy variable that is simply used to cast the problem into a linear programming framework. Boekkooi-Timminga (1989) provides a thorough discussion of several of these alternatives. If the binary programming model expressed in equations (1) through (5) is feasible in that it has an integer solution, then it can be solved using standard mixed integer linear programming (MILP) algorithms (see, for example, Nemhauser & Wolsey, 1988). Several such models have been proposed and investigated using these methods. Considerable attention has also been devoted to methods of speeding up the MILP procedure (see, for example, Adema, 1988, and Boekkooi-Timminga, 1989).

Binary programming models, together with various procedures and heuristics for solving them, have been successful in solving many test construction problems. However, it is not always the case that the model (1) through (5) has a feasible solution. This may occur because one or more of the constraints in equation (3) or (4) is difficult or impossible to satisfy, or simply because the item pool is not sufficiently rich to satisfy all of the constraints simultaneously. In general, the binary programming model is increasingly more likely to be infeasible when the number of constraints is large because of the complexity of the interaction of constraints. Studies reported in the literature have generally dealt with relatively small problems, with pool sizes on the order of 1000 or less and numbers of constraints typically less than 50. By contrast, we typically encounter pool sizes from 300 to 5000 or more, and numbers of constraints from 50 to 300. Moreover, many if not most of these constraints are not mutually exclusive, so that it is not possible to use them to partition the pool into mutually independent subsets. Problems of this size with this degree of constraint interaction greatly increase the likelihood that the model will not have a feasible solution. Heuristic procedures for solving the model often resolve the feasibility problem. Adema (1988) derives a relaxed linear solution by removing an equation. Decision variables with large and small reduced costs are then set to 0 and 1, respectively, or the first integer solution arbitrarily close to the relaxed solution is accepted. Various techniques for rounding the decision variables from the relaxed solution have also been investigated (van der Linden and Boekkooi-Timminga, 1989). Heuristics such as these were designed to reduce computer time, but in many cases they will also ensure a feasible (if not optimal) solution to the binary model if there is a feasible solution to the relaxed linear model.

U.S. Pat. No. 6,712,615 teaches a high-precision cognitive performance test battery which is suitable for internet and non-internet use. U.S. Pat. No. 6,712,615 also teaches a system and method for internet-based cognitive performance measurement. U.S. Pat. No. 6,712,615 provides extensive discussion of important issues. The correlation between test results on separate days, called “test-retest reliability,” is perhaps the most widely used indicator of measurement reliability. The average value of 0.63 did not change appreciably the between 1980 and 2000, indicating that attempts to improve measurement reliability generally met with little success. The discussion in U.S. Pat. No. 6,712,615 makes a strong case for the need of a test system that is accurate to within 1% or 2% so that effective treatments can be identified and describes the need for a measurement system that is far less expensive so that tests can be reasonably repeated frequently (as often as every day), that can be taken at home, without excess cost or need to visit a particular location to take the test, and thus greatly improve measurement precision.

U.S. Pat. No. 6,712,615 also teaches that measurement error can be decreased by reducing practice effects that occur when examinees take the same or similar tests repeatedly. Gradual improvement due to practice is different for each individual and even for each type of response for each individual. Such gradual improvement can mask benefits of medication or other health strategies or can mask harm due to exposure to pollutants and fatigue. The specific benefit of the presently described test method is that an unlimited number of tests can be administered with essentially no test-retest learning or practice effects because of the continual use of novel test items and item-appearance sequences and the absolute simplicity of the single motor response to correct or target stimuli that indicates the correctness of the performance of the cognitive processing of the subject and the speed of that processing. In U.S. Pat. No. 6,712,615 there is a discussion about methods for improving response data to reduce measurement variability and it is pointed out correctly that precision is directly proportional to the square root of the number of data points, if approximately random variation is the cause of imprecision. By providing a test that can be administered repeatedly without test-retest variability and learning effects, like the testing system described in the current application, increased testing sessions can greatly increase precision.

U.S. Pat. No. 5,991,581 teaches an interactive computer program for measuring mental ability that automatically adjusts task complexity and selects letters or symbols with equal probability. There is no discussion of performance measurement precision or test-retest reliability. There is also no determination of the precision with which response time measurements are made.

U.S. Pat. No. 7,070,563 teaches a method which increases the usefulness, sensitivity and specificity of tests that measure memory and facets of memory, including learning, retention, recall and/or recognition.

U.S. Pat. No. 5,079,726 teaches a response speed and accuracy measurement device which does not allow the same digit twice in a row within each 5 digit signal, and several other restrictions are also imposed. 5-digit signals cannot begin with the number 1. Adjacent sequential digits are forbidden. No digit may be used twice within the same 5-digit signal. There are no restrictions placed on the frequency of digits or transitions between digits over a series of signals. One digit, the number 2, appears a disproportionate amount of the time during a series of measurements. If an examinee is especially fast or slow when pressing 2, his average response times will be reduced or elevated in comparison to other measurement sessions, response time variability will be increased and measurement precision will be decreased. There is no effort to limit error rates to maximum or minimum levels or determine the precision with which response times are measured. There exists a need to eliminate computer delay as a source of error. Virtually all computers have hidden “background” processes that occur from time to time and compete with resources required for accurate time measurement. The problem is particularly severe in the most powerful, modern computers which have large numbers of background processes. Every several minutes one or another task is undertaken that delays response time measurement by approximately 5% or more—enough to increase measurement variability beyond the accuracy needed for precise assessment of medical benefits or performance effects from other potentially dangerous or life-saving activities, events or conditions. If several competing programs are active when measurement is made, as much as 100% of the computers central processing unit (“CPU”) time may be occupied, possibly for as long as or longer than several milliseconds.

During the Danbury MS Blueberry Study (Pappas et al., 2001), when interference from background activities was measured before each keystroke during choice reaction time testing, occasional interference was recorded for all study participants, and most had potentially significant interference clusters from time to time. Performance results obtained during this past year during the Danbury MS Blueberry Study indicate that measurement error was limited to 1% or 2% (test-retest reliability was 0.991) and that practice effects were negligible when testing (and therefore practice) was limited to 2 minutes each week. Analysis of response times obtained after interference was detected indicates that apparent response times increased by roughly 7%, depending on the severity of the interference. This 7% error is large enough to a serious concern, but not so large that it cannot be reduced to insignificance by frequent (twice per second) precision checks and rejection of questionable data. The precision improvement methods described in this patent application and employed during the Danbury MS Blueberry Study controlled measurement variability to a greater extent than expected and allowed data sets for individual participants to be split into separate performance measures for each finger used during response time testing. The steady, parallel changes observed for each finger indicate that measurement precision was quite sufficient for this type of single-finger monitoring. A thorough search of prior art has indicated that average measurement precision among 77 different published performance tests was surprisingly low. Test-retest reliability was only 0.63. Results obtained this past year using the methods described herein yielded a test-retest reliability of 0.991. There exists a need for a method for increased measurement precision. The correlation between test results on separate days, called “test-retest reliability,” is perhaps the most widely used indicator of measurement reliability. The average value of 0.63 has not changed appreciably during the last two decades, indicating that attempts to improve measurement reliability have generally met with little success.

U.S. Pat. No. 4,755,140 teaches a hand-held reaction time device which does not determine either test-retest reliability or the precision with which reaction time is measured. The device employs no signal sequence restrictions and other apparent methods for improving precision.

U.S. Pat. No. 5,230,629 teaches a cognitive speedometer for the assessment of cognitive processing speed which includes a display screen, a keyboard, and a processor for generating original data and displaying on the screen the original data for copying by a user on the keyboard. Only if the user copies the displayed original data correctly, the processor generates and displays on the screen different data on which the user is to perform a unit cognitive operation and then enter the resultant data on the keyboard, the resultant data having the same characters as the original data. Only if the user enters the correct resultant data, the processor determines the time required for the user to perform the unit cognitive operation.

U.S. Pat. No. 4,464,121 teaches a portable device for measuring fatigue effects. No two signals in a row can be identical. The reason for this restriction was not to improve measurement precision but to clearly indicate each new trial. This restriction is important since it removes trials where the signal is the same as that just presented and therefore prevents examinees from responding more quickly to such signals than to others and therefore reduces variability among response times and increases measurement precision. The portable device for measuring fatigue effects does not encourage examinees to proceed quickly enough to make a minimum acceptable number of errors and therefore allows more response speed variability than optimal.

U.S. Pat. No. 4,770,636 teaches a cogno-meter which is useful in the repeated testing of memory and concentration, as needed to identify declining cognitive function that may require medical evaluation for dementia, delirium, other medical, psychiatric illness or the cognitive side-effects of medications. The cogno-meter permits repeated cognitive monitoring to be carried out not only in a medical setting, but also alone at home, through the provision of a device for automated, easily repeated testing. The cognitive functions determined by the apparatus are memory and concentration, rather than the speed of the cognitive functions. While memory and concentration are particularly useful foci in many instances, particularly those involving the elderly or the severely affected, in other instances the primary focus should be on the speed with which a cognitive function is performed.

Airplane pilots, racing car drivers and many others are required to make decisions not only accurately, but also rapidly. The cogno-meter provides self-based-paced testing expressly to compensate for the cognitive slowing often present in aged or cognitively impaired persons, although response speed was measured and reported in order to enable identification of excessive slowing which could be an early indication of an impaired cognitive processing.

U.S. Pat. No. 8,740,794 teaches a method for diagnosing, assessing, or detecting brain injury and/or a neurological disorder of a subject. Objects are presented to the subject over a range of locations within the subject's workspace such that the subject can interact with at least some of the presented objects using either the right, left limb or portion thereof of a pair of limbs. Position data and/or motion data and/or kinetic data of the left and right limbs or portions thereof with respect to a presented object are obtained and a data set is acquired for a plurality of presented objects. The acquired data set provides information about brain injury and/or a neurological disorder in the subject. The methods for detecting and assessing brain injuries and/or neurological disorders in subjects involve impaired sensory, motor, and cognitive processes which may be detected and assessed. Movement and interaction within the environment requires a subject to sense the environment using visual, audio and other sensory processes as well as sense his body position and movement. The sensory, cognitive, and motor processes required are normally performed with certain speed and accuracy. When an individual suffers a brain injury from trauma or stroke there can be a broad range of sensory, motor, and/or cognitive functions that are impaired reducing the individual's ability to move and interact within the environment. This leads to a substantive impact on the individuals' ability to perform daily activities. Clinical assessment plays a crucial role in all facets of patient care from diagnosing a specific disease or injury to management and monitoring of therapeutic or rehabilitation strategies to ameliorate dysfunction.

The ability to assess the function of the brain, particularly sensory, motor and cognitive functions is surprisingly limited and continues to be based largely on subjective estimates of performance. Subtle impairments such as small delays in reacting or increases in movement variability cannot be identified easily from visual inspection.

A number of pen and paper tasks have been developed to quantify cognitive processes. Such tasks often do not consider the speed of a subject's ability to complete a task and therefore may be limited in their effectiveness as a tool to assess cognitive processes essential for everyday activities. Automated processes have been developed such as computer based assessments. CANTAB provides a range of specialized tasks to assess various aspects of cognitive function by having subjects use one of their limbs to contact and interact with a computer screen. Devices such as Dyna-vision may be used to quantify how subjects respond to stimuli across a large portion of the workspace by recording the reaction time for the subject to hit various targets that are illuminated at random times. While such technologies provide a range of information on sensorimotor performance, they lack the ability to assess several key aspects of normal sensorimotor and cognitive function that are crucial for performing daily activities.

US Patent Publication No. 2014/0142439 teaches a cognitive function evaluation system which involves prompting a test subject to engage in whole-body movement while tracking movement of the subject. Data can be gathered from the tracking of the person's movement. This data can be compared either with baseline data from an earlier test or with data gathered from other subjects to either make a determination of cognitive function or to evaluate progress in rehabilitation and/or aid in making a determination. Such a determination can be made under realistic activity-specific conditions using increased metabolic rate and/or activity-specific movements that may challenge the subject's cognition to allow for determination of the subject's cognitive function.

US Patent Publication No. 2014/0107429 teaches methods for testing neuro-mechanical and neurocognitive functions which reflect physical and mental compromise that may be associated with traumatic brain injury. A computer-executed method tests neuro-mechanical and neurocognitive function of a subject and measures a subject's performance in a test including one or more test modules designed to challenge neuro-mechanical and neurocognitive functions and compare the performance to one or more baselines to evaluate physical and mental compromise. The methods for testing neuro-mechanical function in addition to neurocognitive function which reflects physical and mental compromise that may be associated with traumatic brain injury and/or other conditions. A computer-executed method for testing neuro-mechanical and neurocognitive function of a subject which measure a subject's performance in a test including one or more test modules designed to challenge neuro-mechanical and neurocognitive function and compare the performance to one or more baselines to evaluate physical and mental compromise and/or improvement after any treatment. In recent years, there has been increased interest in the development and use of computer-based tests specifically designed for sports-associated concussion management (Traumatic Brain Injury in Sports, an International Neuropsychological Perspective, 2004, Lovell et al., Eds., and Sports Medicine, 2005, Patel et al.). Such tests include the Immediate Post-concussion Assessment and Cognitive Testing (IMPACT test), Axon Sport's Computerized Cognitive Assessment Tool (CCAT), and Headminder's Concussion Resolution Index (CRI). The advantages of computerized neurocognitive testing (CNT) include practical aspects, such as ease of administration, cost effectiveness, automated data collection, storage, and analysis, as well as psychometric aspects such as sensitivity to subtle cognitive deficits, availability of alternate forms of test batteries, and precise measurement of multiple domains of performance. CNT has been used for athletes at the K-12, collegiate, and professional level. The athlete is assessed once while healthy in order to create a baseline neuropsychological profile. Following known trauma to the head, injured athletes are reassessed after physical and other reported symptoms have cleared to determine if cognition has returned to baseline levels. Physicians and sports medicine professionals utilize CNT results in addition to patient history and physical examination as the basis for return-to-play decisions. Despite the remarkable potential offered by computerized neurocognitive testing and interest by clinicians in using it, several problems exist with current programs. The first of these is that the CNT data used as the basis for these medical judgments may be unreliable because both the baseline and post-injury neuropsychological assessments are performed by comparing the results of a single test when the results of both may be unrepresentative of the athlete's characteristic performance. Unreliability of single-test results stems from the inherent variability of human performance. Any individual's performance on a CNT administered at a particular time can be influenced by many factors unrelated to injury, treatment, practice effects, or unreliability of the CNT itself. Such factors include, for example, fatigue, blood sugar levels, drug use, emotional stress, and motivation. These factors may or may not be discoverable, but even if discovered, their influence on results cannot be calculated or estimated with any degree of certainty. The results of a single CNT therefore may reflect performance levels that are potentially much higher or lower than the individual's normal performance capability. The only confident claim that can be made about the results of a single CNT is that they may be within that particular individual's normal performance range. Where the results fall within that range is unknown and cannot be determined from the results of a single CNT administration. When evaluating an individual's return to baseline cognition levels, a typical approach is to calculate the difference between an individual's post-injury and baseline single test scores. But the difference between results at these two points in time will be influenced to some degree by the individual's natural performance variability. If their baseline scores were taken when they were performing near the lower end of their “uninjured” range and their post-injury scores were near the upper end of their “injured” range, the difference between the two would be relatively small. If the circumstances were reversed (i.e., high baseline and low post-injury) the difference would be relatively large. In neither case would the results accurately reflect change due to recovery. In critical return-to-play decisions using data for which so much uncertainty exists is questionable, no matter what analysis is used. Existing CNTs and their implementation approaches use various forms of population data (or sample data if population data are not available) as comparative standards due to the impossibility of calculating meaningful individual performance variation estimates using single data points. Normalizing an individual's CNT results based on their own performance variation is therefore not possible. Using population or sample data as the basis for return-to-baseline evaluation is known to be problematic.

Iverson, Lovell, and Collins have stated, “The . . . reliable change estimate is optimized for the entire sample but is not as accurate for subsamples, such as the top 20%, middle 60%, and bottom 20% of scores.” See Iverson et. al., “Interpreting Change on ImPACT Following Sport Concussion” The Clinical Neuropsychologist, 2003, Vol. 17, No. 4, pp. 460-467. A single individual is the logical minimum subset of a population or sample, and the effects of the sub-optimization described by Iverson is particularly pronounced at that level because the variation of a population or sample can be roughly two to more than four times as great as that for an individual. Using a larger variation figure as a basis for a return-to-baseline judgment may result in lower normalized offsets from baseline values. Calculations made using larger variation values increase the possibility that baseline levels will be erroneously judged to have been restored, and consequently, that individuals who have not been restored to health will be returned to play prematurely. A second potential problem with existing CNT instruments is that the test-retest reliability of several existing programs has been questioned. See Broglio et al., “Test-Retest Reliability of Computerized Concussion Assessment Programs,” J. Athletic Training, 2007, vol. 42, pgs. 509-514. Specifically, a study of healthy student volunteers who completed the IMPACT, Concussion Sentinel, and Concussion Resolution Index tests showed low to moderate test-retest reliability coefficients. A control test, the Memory and Concentration Test for Windows was also administered to insure that the test results were not flawed due to sub-optimal effort. Since these three programs did not provide stable measures of cognitive functioning in healthy subjects, their utility in assessing post-concussive patients was questioned.

The United States military has attempted to use its CNT more extensively than commercial instruments that have targeted sports applications. The Automated Neuropsychological Assessment Metrics test is a computer-based tool developed by the U.S. Army to detect the speed and accuracy of attention, memory, and thinking ability.

On May 28, 2008, a memorandum was issued by the Assistant Secretary of Defense making mandatory pre-deployment neurocognitive assessment for all service members. The baseline information collected in the assessment was then to be utilized in the event that a service member is injured in conflict, such as sustaining a concussion or traumatic brain injury in an explosion. The ANAM test has been widely administered to military personnel prior to combat deployment and following traumatic brain injury in support of return-to-duty determinations, in similar fashion to application of commercial CNTs in sports. It has been administered to service members upon return from combat service in an attempt to detect cognitive indicators of possible unreported and/or undetected TBI. The Department of Defense has become increasingly aware of the deficiencies of the ANAM test for these stated purposes. See Zwerdling et al., “Military's Brain-Testing Program a Debacle,” NPR Report, NPR.org, posted Nov. 28, 2011. A recent investigation has found that Pentagon's civilian leadership ignored years of warnings about the ANAM test. The military's highest ranking medical officials have said the test was flawed and no better than a “coin flip” (“Military Fails on Brain-Test Follow-ups,” Armytimes.com, posted Jun. 14, 2010). Recent research has also noted practice effects in five of six ANAM 4 subtests. Such practice effects must be taken into account or the results of subsequent assessments may be incorrectly attributed to patient improvement (Eonta et al., “Automated Neuropsychological Assessment Metrics: Repeated Assessment with Two Military Samples,” Aviation, Space, and Environmental Medicine, 2011, vol. 82, pgs. 34-39).

CNT has been suggested for early detection of cognitive decline in the elderly. However, a systematic review of eleven test batteries appropriate to cognitive testing in the elderly showed great variability in manner of administration and wide variance in the level of rigor of validity testing (Wild et al., “The Status of Computerized Cognitive Testing in Aging: A Systematic Review,” Alzheimer's Dement., 2008, vol. 4, pgs. 428-437). There exists a need for a computer-based testing method that accurately reflects physical and mental compromise and provides a prompt and sensitive indicator of existing or developing TBI, including concussions. There exists a need for a computer-based method that provides an accurate indicator of physical and mental improvement in a subject after a TBI and any treatment thereof.

There also exists a need for a computer-based testing method that accurately reflects physical and mental compromise that may be associated with other impairments to brain function caused by drug use prescription, non-prescription or illicit, alcohol use/abuse, disease (dementia, Alzheimer's), depression, aging, fatigue, trauma suffered at birth, exposure to toxic chemicals, post-traumatic stress disorder and the like. There exists a need for a computer-based method that provides an accurate indicator of physical and mental improvement or progression in a subject after treatment of an underlying condition. A further need exists for a computer-based testing method that establishes statistically relevant subject baselines and population baselines to provide improved indicators of compromise and subsequent recovery in both the young and elderly.

US Patent Publication No. 2013/0123341 teaches methods for diagnosing Alzheimer's disease. The disease occurs in two forms: familial (FAD) and sporadic (SAD). FAD is diagnosed in part by relevant family history and by indications of the condition including degeneration or reduction in language, memory, perception, behavior, personality and cognitive skill. Neither of these methods of diagnosis is quantitative and often leads to a diagnosis only after the FAD has pathologically progressed. For the second and more common type of Alzheimer's disease, sporadic Alzheimer's disease (SAD) diagnosis of SAD is accomplished by clinical findings.

Diagnosis has been attempted using neuro-radiologic procedures such as magnetic resonance imaging scans and neuropsychological tests. A quantitative method of diagnosing both types of Alzheimer's disease, especially SAD, remains a complicated and unattained goal of medical research. There remains a need for a rapid, efficient, and universal method for determining presence of Alzheimer's disease, a condition which has been difficult or impossible to diagnose with any commercially available method.

US Patent No. 2005/0196735 teaches methods for assessing memory in a subject and for screening for agents directed to treating or preventing memory impairment and dementia characterized by memory impairment. Memory tests provide within-person measures of memory impairment, in addition to normative between-person measures of memory impairment, and include detecting memory impairment by decreased recall and discrimination of the second of two coordinated lists of items to be recalled from memory.

Concussion, also known as mild traumatic brain injury, has recently become widely recognized as a significant cause of disability in athletes. The currently accepted definition of concussion that this injury represents a functional more than structure disorder alludes to the fact that concussed athletes suffer from symptoms referable to disruptions in multiple physiologic systems, resulting in a diminution of overall physical performance. Studies show that sending an athlete back into action before the concussion or other neurological injury has healed may lead to further concussions in the short term, which may lead to permanent neurological defects in the long term. Decrements in cognition vestibular and visual performance have been shown to be negatively affected by concussion. It is well known that the increased metabolic demands associated with physical activity typically exacerbate these symptoms. In light of these facts, it would appear logical that in order to accurately evaluate and rehabilitate an athlete who has experienced a concussion that a comprehensive approach be utilized, one that addresses all aspects of the problem. One tool utilized for the assessment of the ability of the athlete to return to play following concussion is IMPACT, a commercially available product that is categorized as a computer-based neurocognitive examination. There is an abundance of peer reviewed literature supporting its use in this capacity. The athlete is determined to have “recovered sufficiently” from his concussion once his IMPACT scores return to baseline or above. Current tests employed to assess the concussed athlete's ability to return to play (such as IMPACT) measure isolated capabilities. Such isolated testing does not accurately evaluate the athlete. While IMPACT has been validated as a useful tool to determine restoration of baseline cognitive function following concussion, it does not adequately address cognitive problems associated with concussion. Tests such as IMPACT are neurocognitive tests for concussion recovery assessment measuring the speed and accuracy of tests of attention, speed, learning and working memory. Such tests are limited to the measurement of isolated capacities. In view of the above defects with current methods and systems, improvements in evaluation systems and methods would be desirable.

US Patent Publication No. 2014/0107494 teaches that cerebral blood flow data during cognitive task execution can be measured using a functional near infrared spectroscopy method, then characteristic amount extraction is performed after performing primitive analysis on the measured cerebral blood flow data. By using the extracted characteristic amounts and a pre-built model for employing in determination of cognitive impairment, automatic determination is made into clinical diagnostic groups of normal (NC), mild cognitive impairment (MCI) and Alzheimer's disease. It is thereby possible to perform cognitive impairment determination that is suitable for mass early stage screening of elderly people.

Currently screening for dementia includes, for example: a revised version of Hasegawa's Dementia Scale (HDS-R), as described in “Katoh, S., Simogaki, H., Onodera, A., Ueda, H., Oikawa, K., Ikeda, K., Kosaka, K., Imai, Y., and Hasegawa, K.: Development of the revised version of Hasegawa's Dementia Scale (HDS-R), Japanese Journal of Geriatric Psychiatry, Vol. 2, No. 11, pp. 1339-1347 (1991), (in Japanese)”; Mini-Mental State Examination (MMSE) as described in “Folstein, M. F., Folstein, S. E., and McHugh, P. R.: “Mini-Mental State”: A practical method for grading the cognitive state of patients for the clinician, J. Psychiat. Res, Vol. 12, No. 3, pp. 189-198 (1975)”; and Clinical Dementia Rating (CDR) as described in “Morris, J. C.: The Clinical Dementia Rating (CDR): Current version and scoring rules, Neurology, Vol. 43, No. 11, pp. 2412-2414 (1993). Such dementia screening methods are similarly widely used to tests based on neurophysiology such as functional MRI (fMRI), FDG-PET, and CSF biomarkers, as described in “Zhang, D., Wang, Y., Zhou, L., IA Yuan, H., Shen, D., and The Alzheimer's Disease Neuroimaging Initiative: Multimodal classification of Alzheimer's disease and mild cognitive impairment, Journal of Neuroimage, Vol. 55, No. 3, pp. 856-867 (2011)”. These are performed by doctors who have received a given amount of training or clinical physicians, mainly in medical institutions. In the normal outpatient scenario, although these are simple investigations, such as HDS-R, a doctor takes about 5 to 20 minutes to perform the investigation. It is accordingly pointed out that this has a negative impact on the treatment of other outpatients, with consideration given to the need to reduce the burden on doctors. Known tests based on neurophysiology such as fMRI, FDG-PET and CSF biomarkers mentioned above are described in “The Alzheimer's Disease Neuroimaging Initiative: Multimodal classification of Alzheimer's disease and mild cognitive impairment, by Zhang, D., Wang, Y., Zhou, L., Yuan, H., Shen, D., and Journal of Neuroimage, Vol. 55, No. 3, pp. 856-867 (2011)”. Although these tests are non-invasive, due to the many limitations, such as the difficulty of taking spinal fluid samples, radiation exposure, the large size of measurement apparatus, and the need to restrain test subjects, they are not suitable for mass early stage screening of elderly people. If a tool could be developed that was more simple and easier to use and also had equivalent performance or better than that of existing tools, physicians would then be able to further widen the scope of implemented screening. This would accordingly enable a contribution to be made to early stage diagnosis of dementia.

US Patent Publication No. 2007/0291232 teaches a method for determining mental proficiency level by monitoring point of gaze, pupillary movement, pupillary response and other parameters in a subject performing a task, collecting the data in a database, analyzing the data in the database and assigning the subject to a score indicating the subject's particular mental proficiency level in real time. The methods for computer based testing are known to the art.

The applicant hereby incorporates the above referenced patents and patent publications into his specification.

### SUMMARY OF THE INVENTION

The invention is a method for assessing cognitive function in a subject uses a computer having a display, a response sensor and a microprocessor and includes the step of using the display to present to the subject a plurality of items to be analyzed by the subject. The items presented to the subject are intermixed with other of the items being tested for recognition.

The first aspect of the invention is that the method also includes the step of having the subject activate the response sensor after the subject has looked at the display and has recognized the presented items from memory wherein the subject is tested to determine if the subject recognizes each of the items as meeting a specific criterion.

The second aspect of the invention is that the method further includes the step of using the microprocessor to determine the subject's accuracy and his response speed to each of the recognized items wherein the response speed for each of the recognized items is the time required between when the subject is shown an item and when the subject correctly responds that he recognizes the item.

In the third aspect of the invention a microprocessor is used to analyze a plurality of response speeds for the recognized items in order to create a report of his accuracy and his response speed; and

In the fourth aspect of the invention the microprocessor is used to send to the subject the report of his accuracy and his response speed.

In the fifth aspect of the invention the microprocessor is used to request compensation from the subject for an analysis of the report of his accuracy and his response speed.

In the sixth aspect of the invention the microprocessor is used to receive the compensation from the subject which the subject provides.

In the seventh aspect the microprocessor is used to request that the subject provide personal information upon receipt of the compensation.

In the eighth aspect of the invention the microprocessor is used to receive the personal information which the subject provides.

In the ninth aspect of the invention the microprocessor is used to analyze the subject's accuracy and response speed to each of the recognized items.

In the tenth aspect of the invention the microprocessor is used to report to the subject an evaluation of his performance of cognitive function.

The eleventh aspect of the invention a system to determine the presence of temporary mental impairment for use with a computer having a display, a response sensor and a microprocessor includes an aural generator which generates an aural stimulus in the form of a sound to be heard by a subject, a receiver which receives a vocal response to the aural stimulus from the subject and a measuring device which measures the vocal response to determine mental impairment of the subject for the ability to safely operate machinery wherein the sound is either verbal or non-verbal.

The twelfth aspect of the invention a method for both assessing cognitive function in a subject and testing neuro-mechanical and neurocognitive function of a subject wherein the method of testing neuro-mechanical and neurocognitive function of the subject includes the steps of using the microprocessor to render a test including at least one test module for displaying on the display the test to the subject, using the microprocessor to generate a request for subject's input indicative of subject's response to the displayed test, using the microprocessor to receive the subject's input indicative of the subject's response to the test, using the microprocessor to compute at least one subject score as a function of the received subject's input and using the microprocessor to compare the at least one subject's score to at least one of the subject's baseline including a subject's baseline wherein the subject's baseline includes a mean score and a standard deviation computed from a plurality of subject's scores obtained from previously completed tests by the subject and using the microprocessor to provide at least one of the subject's scores and providing the score comparison for displaying to the subject.

Other aspects and many of the attendant advantages will be more readily appreciated as the same becomes better understood by reference to the following detailed description and considered in connection with the accompanying drawing in which like reference symbols designate like parts throughout the figures.

The features of the invention which are believed to be novel are set forth with particularity in the appended claims.

### DESCRIPTION OF THE DRAWINGS

FIG. 1 is a block diagram of a suitable computing environment in conjunction according to U.S. Pat. No. 8,475,171.

FIG. 2 is a flowchart of a generalized technique for analysis of cognitive status using VR testing according to U.S. Pat. No. 8,475,171.

FIG. 3a is a photograph of a slide show for MEMTEST according to the present invention.

FIG. 3b is a photograph of the slide show for MEMTEST according to the present invention.

FIG. 4 is a table showing the results of MEMTEST of FIG. 1.

FIG. 5 shows a relationship between age and mean hit rate and mean correct rejection rate in 868 individuals on the VNBT with each data point representing the performance of an individual participant.

FIG. 6 shows a relationship between discriminability (d′) and age on the VNBT with each data point representing the score (d′) of an individual participant. One individual whose score was unusually poor (d′=−2.64) was removed from the plot. The dashed line shows an inverted exponential regression curve which was initially fitted to 4 minus the d′ values.

FIG. 7 shows a relationship between discriminability performance (d′) and age in 868 individuals on the VNBT with numbers inside the bars indicating the group n. The bars show the mean discriminability score for each age group and brackets show SEM.

FIG. 8 shows the same data is shown with brackets showing one standard deviation on either side of the mean.

FIG. 9 shows a relationship between discriminability performance (d′) and education in 868 individuals on the VNBT with numbers inside the bars indicating the group n. The bars show the mean discriminability score for each age group and brackets show SEM.

FIG. 10 shows a relationship between the number of intervening items (between initial and first repeat presentations) and percent correct on those items across 868 individuals on the VNBT with the brackets showing SEM. Each item was shown for 5 seconds so the correspondence with the temporal interval can be calculated.

FIG. 11 shows a relationship between percent correct and item repetition in 868 individuals on the VNBT when eleven items were shown three times during the test. Recognition performance increased between the second and third presentation (average number of intervening items=21.1, range; 10-36 items). A paired t-test demonstrated that the difference was significant (p<0.005).

FIG. 12 is a diagram of a first computer for use in a method for assessing cognitive function in a subject according to a first embodiment of the present invention.

FIG. 13a is a first partial schematic drawing of a flowchart of the method for assessing cognitive function in a subject of FIG. 12.

FIG. 13b is a second partial schematic drawing of a flowchart of the method for assessing cognitive function in a subject of FIG. 12.

FIG. 13c is a third partial schematic drawing of a flowchart of the method for assessing cognitive function in a subject of FIG. 12.

FIG. 14 is a diagram of a second computer for use in a temporary mental impairment determination system according to a second embodiment of the present invention.

FIG. 15 is a diagram of a third computer for use with a computer-executed method for testing neuro-mechanical and neurocognitive function in a subject according to a third embodiment of the present invention.

FIG. 16a is a first partial schematic drawing of a flowchart of the computer-executed method for testing neuro-mechanical and neurocognitive function in a subject of FIG. 15.

FIG. 16b is a second partial schematic drawing of a flowchart of the computer-executed method for testing neuro-mechanical and neurocognitive function in a subject of FIG. 15.

FIG. 17a is a first partial schematic drawing of a flowchart of the method for both assessing cognitive function in a subject and testing neuro-mechanical and neurocognitive function according to a fourth embodiment of the present invention.

FIG. 17b is a second partial schematic drawing of the flowchart of the method for both assessing cognitive function in a subject and testing neuro-mechanical and neurocognitive function of FIG. 17a.

FIG. 17c is a third partial schematic drawing of the flowchart of the method for both assessing cognitive function in a subject and testing neuro-mechanical and neurocognitive function of FIG. 17a.

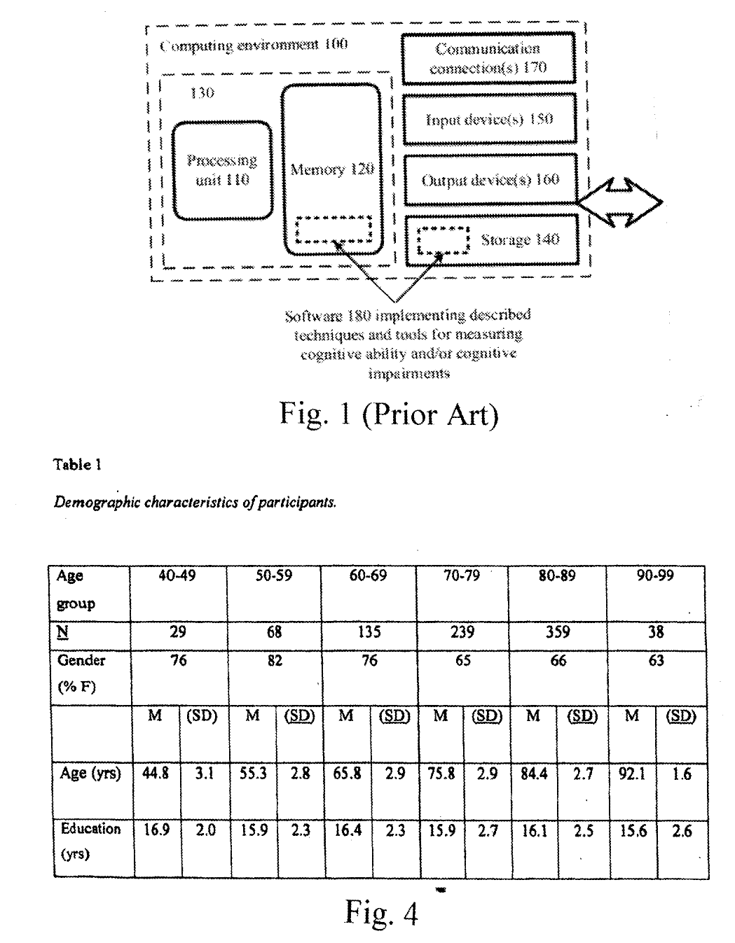

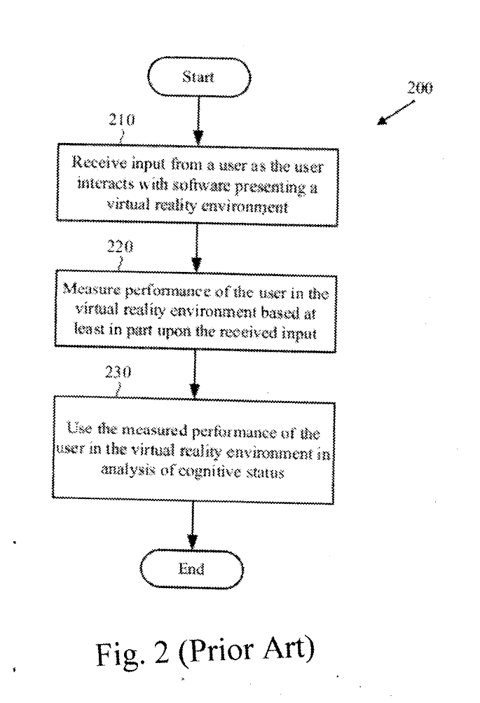

### DESCRIPTION OF THE PREFERRED EMBODIMENT

MemTrax Test consists of specifications for tests and games (the TEST) designed to measure cognition. The specific aspect of cognition assessed by the TEST is retentive memory, the mental function that most specifically deteriorates with increasing age and that declines in the time before and during a diagnosis of dementia. The TEST also assesses related aspects of cognition. The TEST is a brief slide show, administered by a computer (in any format, computer-program, or platform) which displays a series of visual image stimuli (pictures or words) and records the performance of tested subjects on each image. A major aspect of cognition is memory. Memory involves the retention of perceived information, whether it is for an immediate circumstance (attentive memory), preserved for an indefinite period of time after the immediate circumstance has changed (retentive memory), or maintained for long periods of time, days, weeks, months, after the information was perceived (persistent memory). The earliest sign of Alzheimer's disease is generally considered an impairment of retentive memory, and this type of memory is also known to deteriorate substantially with the normal aging process.

1) Retentive Memory—Information Retention after distraction (minutes to hours, short-term memory, declarative memory).
2) General Attention—Attention to the task and the information presented.
3) Perceptual Attention—Attention to information details, which may include discriminating differences between pictures or words.
4) Recognition Reaction Time—Time to perceive an item of information and react according to the instructions of the test.
5) Attentive Memory—Information retention before distraction (for the duration of attention without distraction, e.g., before an intervening stimulus, immediate memory, working memory). Persistent Memory—Information that is maintained for long periods of time such as days to years, long-term memory, semantic memory. The TEST displays a series of images and a portion of the images are repeated. The novel aspect of the TEST is that duplicated images are interspersed with images being shown for the first time. As the series advances, the individual being tested must make a binary decision when each image appears, whether the image is a target (e.g., a repeated image that is recognized) or a non-target (e.g., a new image to be observed and retained). Memory performance is reflected in the percent of previously shown pictures that are recognized. Validity and attention are indicated by the percent of pictures shown for the first time which are perceived as being new images. Recognition reaction time can be measured. Images are selected to test specific aspects of perception and memory and may be pictures or words. The attributes of the images (e.g., nameable, memorable) can be varied to assess a broad range of cognitive abilities. The difficulty of the TEST may be adjusted to test retentive memory across a broad range of ability and with narrow precision. Variations of the TEST can more specifically assess general attention, perceptual attention, attentive memory, and persistent memory. The MEMTRAX Memory Test has particular utility to detect memory dysfunction in subjects otherwise appearing normal that have very early Alzheimer's disease or other related types of dementia.

The MEMTRAX Memory Test is a method to assess retentive memory. The correct response of a subject which is examined is an indication that a particular image on a slide is a repeat of an image from a prior slide. The indication is most simply a press of a button, usually either the space bar on the computer keyboard or a touch of a touch sensitive screen as on a mobile phone. The indication may also be pressing one of two buttons, one to indicate recognition of the picture, one to indicate non-recognition of the picture. Other types of overt behavior may also be used as indicators of response, including any movement or vocalization. Performance is tallied as correct recognitions (percent correct indicates retentive memory function) and correct rejections (percent non-responses or non-recognition indicators to initial presentations indicates level of perceptual attention to the stimuli and the validity of the memory assessment value). Signal detection theory provides measures d′ which is an estimate of discrimination between non-target and target items, beta which an estimate of the tendency to be more likely to respond to a target than a non-target, and C which is a measure of the tendency to respond as opposed to not respond (more independent of the d′ measure than beta). Receiver operator characteristic analysis uses sensitivity and specificity measures to determine how much information is provided by a test given a range of cut-offs for making a particular decision. Item Response Theory provides information about the performance of individual test items with respect to difficulty, discriminability and goodness-of-fit, with an established method to use this information to estimate a subject's level of function (as used by the Scholastic Aptitude Test and IQ tests). Neural Network Model analyzes each item for its weighted relationship to the outcome measure in the context of all of the other items. Reaction time can also be measured. Measurement of the reaction time to a response to a repeated picture indicates how quickly the subject is able to process, perceive, and recognize the information as a repeated item. If measurement is made of reaction time to new pictures, the reaction time indicates the time which the individual processes and perceives information and makes an attentive decision that the information has not been perceived previously during the test. Another way that the test can be administered is by showing slides to an audience. Audience members can respond to repeated slides by indicating that a numbered slide is a repeat of a previously shown image. The audience member can make this indication either by marking a numbered sheet (attached paper) or by pushing a button on a “polling transmitter”. The test may contain any number of images, but works well with as few as 40 slides and 15 unique pictures. A second administration with a different set of stimuli in a different order can be used to confirm or further specify the levels of the various aspects of memory function. Alternatively, a longer test can be administered in which hundreds of slides are shown, with repeated slides interspersed. Between the initial presentation of an image and the repetition of the image, the test must contain a minimum of one intervening images, usually 5 to 20 images, and possibly over 200 images. Images may be repeated additional times, providing some items easier to recognize for more impaired and older individuals, so that performance in impaired ranges can be precisely assessed. Key features of the MEMTRAX Memory Test design are:

1. A variable N-back design memory test for a series of stimulus presentations. For testing of retentive memory, N must be at least 2, possibly over 20, and is variable, with an average of at least 5.
2. This N-back design memory test can use photographs of objects and other images.
3. The specific photographs and electronic images dedicated to this test.
4. The specific images and photographs include, but are not limited to, representations of nameable and un-nameable objects in the environment, scenes of any kind, line-drawings, abstract representations, text, and combinations of these. The specific images and photographs extend to IA faces (male and/or female), words (nouns, verbs, etc., abstract, concrete, simple, complex) and line drawings which vary from concrete, nameable to abstract and un-nameable.
5. The duration of a single test is from 30 seconds to 30 minutes. Optimal implementation is 3 minutes for elderly individuals. The test has a multitude of similar versions, so that the test can easily be repeated several times without the individual seeing repeated stimuli.
6. In the N-back design, images are shown for an initial presentation and then are subsequently shown later in the series to see if the subject recalls having seen the image before in the series. The subject may respond with a simple button (bar) press, for either recognition or non-recognition, and other buttons may be used to discriminate these response options.
7. The reaction times of the responses are measured.
8. Scoring of this test is percent correct=true positive/(true positives+false negatives) and percent new identification=true negatives/(true negative+false positive). Reaction time is a performance measure. Other scoring methods include use of Item Response Theory, Receiver-Operator Characteristic Theory, and Neural-Network Analysis, which can enhance the precision and stability of the TEST results, both for assessing memory in younger individuals through a continuum of such measures to the purpose of detecting early Alzheimer's disease. Another analytic method includes signal detection theory.
9. Many memory tests have been developed and have been widely used. This test is unique in its design for automatic administration and scoring as a brief test, using interspersed new and repeated images and a specified order of display.
10. The TEST can assess a broad range of memory function. Different versions of the TEST may use longer display times (3 to 10 seconds) and specially selected, predominantly easily discriminated images, for the purpose of detecting mild memory problems in elderly individuals that are in the early stages of developing Alzheimer's disease. Alternatively, images which are more difficult shown for shorter display times under 3 seconds may be used to measure high levels of memory function, particularly in younger individuals.
11. The different versions of the MEMTRAX Memory Test may be directly compared due to the pre-tested comparability of various sub-categories of item bundles so that an unlimited number of test versions can be available, while any version is able to reliably estimate an individual's memory on the specified continuum of retentive memory function. The memory function of an individual may be evaluated precisely over time and evaluated for small but significant changes.
12. The TEST is surprisingly well-received by subjects, who nearly unanimously agree that the TEST is fun to take potentially more than either a cross-word puzzle or a sadoku. Subjects are willing to take the TEST repeatedly over a period of time, which increases the likelihood that a subject will take the TEST enough times for a significant change to be detected if it occurs.
13. The images used in the MEMTRAX Memory Test are unique in their grouping and selection for testing a broad range of memory function precisely.
14. The order with which the images are displayed is unique for measuring retentive memory and establishing validity of the measurement. The MEMTRAX Memory Test involves looking at a number of images and indicating which are duplicated. In the Memtrax Memory Test, correct responses are defined before the slide show begins. The instructions are: “(NUMBER) images will be shown. Carefully look at each image. When you see an image for the first time, look at it carefully and try to remember it. If you see an image that you have seen before, respond to indicate that you recognize the image.”

The administration of the TEST by computer to an individual requires the following:

1) A slide or text-file which specifies the directions for performing the test which will be shown to the test taker (the subject taking the test).
2) A file with the identifiers of the specific images to be shown.
3) A file which contains the order in which images should be shown.
4) An algorithm for preliminary analysis of the test data.
5) The database that will store and the system to analyze the test data.

Memory function generally deteriorates with age, and memory impairments are a commonly unrecognized symptom of dementia. The objective was to characterize an audience-based memory test suitable for simultaneous screening of a large number of individuals.

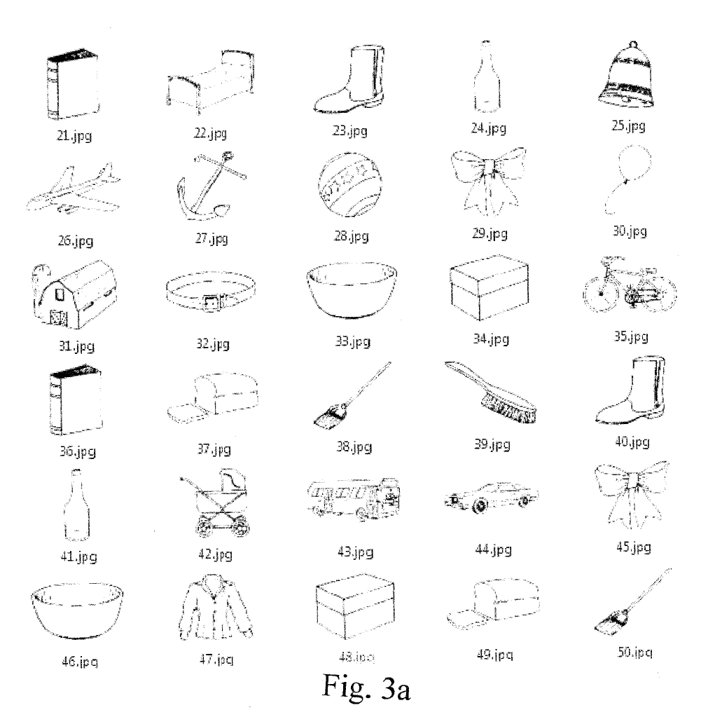

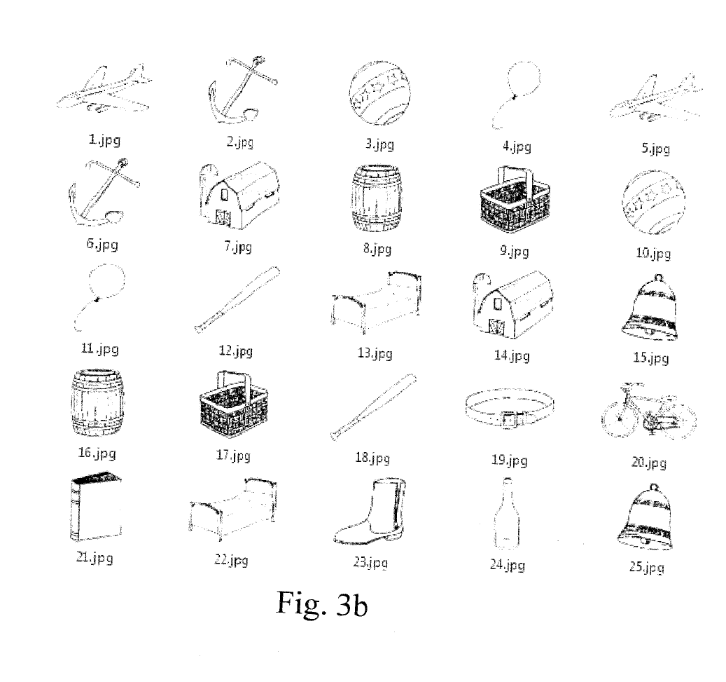

Referring to FIG. 3a and FIG. 3b the TEST can also be administered as a slide show such as Microsoft PowerPoint with the pictures and picture orders pre-established, each image shown for 5 seconds automatically for which subject performances in an audience can be assessed either by a pencil and paper with the audience members indicating the number of a slide which they think is a repeat and by audience voting electronic technology where audience members indicate if they think a picture is repeated and the data for each individual's performance is stored in the administering computer's memory such as Turning Point Technologies. The TEST was developed to assess recognition memory in audiences using a slide-show with 50 images, of which 25 are repeated. Audience members responded by recording if an image was a repetition. In test administrations to over 1050 participants, 868 individuals aged 40-97 years provided complete data. Recognition memory performance as measured by discriminability (d′) showed a progressive, exponential decline with age and a progressive increase in variability. Individuals with low levels of education had lower scores than those with more education. Gender showed no effect. This audience-based memory test was sensitive to effects of both age and education. Such memory tests represent a practical approach to screen for early dementia and further development of this type of test is warranted. One critical issue is to define suitable cut-points for memory screen failure, since the same value is not appropriate for both young and old individuals. The cut-point should also reflect cost-worthiness of screening relative to age. Memory impairment is often the most disabling feature of many pathological processes including neurodegenerative diseases such as Alzheimer's disease or stroke. Epidemiological studies indicate that 5% to 15% of adults aged 70 years and older exhibit signs of dementia and memory impairment is a core feature of dementia. Despite widespread understanding of the significance of memory disorders, they often go unrecognized. Several factors interfere with the detection of memory impairment associated with dementia, including a failure to screen, avoidance of this difficult problem by affected individuals and their health care providers, and under use of available testing methods. With changes in the delivery of health care, physicians must work under strict time constraints, leading many physicians to not routinely screen their patients for dementia. One solution to the failure to detect memory impairments is to implement large-scale community memory screening. Numerous approaches have been advocated to screen for memory problems in the community, and studies demonstrate that such programs can detect such individuals. Community screening programs are logistically difficult. Currently available memory tests must be administered by a trained psycho-metrician in a one-to-one interaction in a confidential, quiet environment. Such tests are expensive to administer and uncomfortable for the individuals taking the tests, leading to poor motivation for repeat testing. Audience-based methods for testing large numbers of individuals simultaneously have not been widely developed as cognitive screening tools. Such tests could be used to screen groups of people for memory problems in order to identify high-risk individuals for further evaluation because memory impairment associated with dementia is commonly undiagnosed, a simple audience-based memory test designed to detect patients with early dementia would be valuable. A significant issue is how to assess the utility of an audience-based memory-screening test to detect early dementia. Any population of older adults will contain individuals with diverse memory impairments. Alzheimer's disease is the most common form of dementia, accounting for approximately two thirds of all dementia cases. The initial symptom of is typically a prominent amnesia in which the core symptom is difficulty in encoding new information. Even when patients with early Alzheimer's disease can perceive and immediately reproduce new information such as repeating a series of words, many neuropsychological studies have shown that the encoded information is easily lost under conditions of delay or interim distraction. This specific type of memory impairment in Alzheimer's disease has led to the suggestion that Alzheimer's disease pathology is specifically affecting basic mechanisms sub-serving neuroplasticity. The process of memory encoding can be tested in several different ways. Recognition memory tests are especially suitable for this purpose as they provide the target stimuli within the test framework. Poor performance on a test of recognition memory provides strong evidence for an underlying encoding impairment, raising the possibility of an emerging Alzheimer process. In contrast to individuals with early Alzheimer's disease, healthy adults can quickly and accurately encode massive amounts of new information. Landmark studies in the 1960s, 1970s, and 1980s demonstrated that healthy individuals perform well above chance on tests of recognition memory after viewing thousands of images for a few seconds each and after viewing highly complex images. Taken together with the encoding deficits found in early Alzheimer's disease, these studies suggest that recognition memory tests should provide an effective screen for early Alzheimer's disease. It is important to note that even though recognition memory has a huge capacity in healthy adults, it is nonetheless vulnerable to age-associated cognitive decline and increased age is associated with lower levels of performance. The aim of the current study was to measure Alzheimer's disease-related memory performance in an audience population. For this purpose a variable N-back task (VNBT) was designed n to detect memory problems in audience members. The VNBT was designed to be interesting in order to maintain audience attention. The current study sought to characterize this repeat detection task and evaluate age-related changes in recognition memory in order to determine normal performance ranges. The VNBT performance was expected to decrease with age. The VNBT was administered to over 1050 subjects between July, 2007 and June, 2008 at 26 sites such as community events, senior citizen centers and retirement living communities in San Francisco Bay Area. The audiences ranged from 9 to 142 individuals (M=39; SD 34; range 9-142). There were 940 subjects who appropriately performed the memory test, and of these participants, 868 individuals provided three specific demographic items of information: age, education, gender (age: M=75.9 years old; SD 11.4; range 40.0-97.6; education: M=16.1 years; SD 2.52; range 6-21; gender: 68.7% female). In this group 86.6% of the participants were reported being “white”.

Referring to FIG. 4 participants were divided into six sub-groups according to age. Education level declined by 1.3 years from 16.9 to 15.6 from the youngest to the oldest age group, though the variation did not reach statistical significance (F 5, 867)=1.93, p>0.05). All age groups contained more females than males. The groups varied significantly in the number of males to females (N=868)=12.9, p=0.02). The audience-based memory test was developed for testing recognition of easily remembered images. A “variable-N-back task” (VNBT or repeat detection after multiple intervening stimuli) format was used with numerous complex visual stimuli. Generally the images were of discrete objects, though similar objects and difficult to name objects were used to avoid strict reliance on verbal cues, provide a challenge, and maintain the interest of the subjects (the assortment of images was developed over several years). This approach reduced the ceiling and floor effects (only 8% of the subjects had a perfect score). Although audience testing is used widely in educational assessment, such testing procedures are unusual in cognitive neuroscience or clinical research. A primary aim of the study was to demonstrate that a recognition memory test can be administered to a large number of individuals simultaneously. Twenty-five color images (digital camera) of manmade items were selected from a range of pictures. From these 25 items, a 50-item recognition memory test was constructed in the following way. The 25 items were first arranged in a random sequence, with repeated images interspersed. Fourteen of the items were one-time repeats and were inserted among the initial presentations of the test items. Eleven of these items were shown for a third time, making recognition easier for subjects with impaired memories, providing more learning regarding a particular stimulus set, and allowing a comparison of first repeat recognition with second repeat recognition. The order was arranged such that there was an average inter-repetition-interval to the first repeat of 7.93 items (range=2 to 25 intervening items). The eleven items that were second repeats were inserted into the test with an average inter-repetition interval of 21.1, (range=10 to 36 items between the second and third presentations). The eleven un-repeated test items served only as foils. The 50 items were numbered in sequence (1-50) with a large numeral in the top left hand corner and transferred to a PowerPoint presentation. A second series of ten items was constructed using similar color images and was used as a practice test before the full test was given (5 images, 3 repeated once, 2 repeated a second time). The need for such a practice test had become obvious during pilot work, which indicated that about 10% of audience members could not follow the verbal instructions on the first try. Participants were provided with a single sheet of paper. Demographic information was collected on one side of the page (age, education and race) and the other side was used as an answer sheet for the recognition memory testing. The answer sheet had columns of numbers corresponding to the 10 slides of the practice-test and the 50 slides of the full test. A single circle was adjacent to each number on which a subject could indicate their response by filling in the circle, and the sheet was organized so that it could be scanned for data entry. Testing at all sites adhered to a standard format, which began with a 20-minute introductory talk, with slides about Alzheimer's disease and the signs of dementia. As part of the talk, all participants were offered the VNBT memory test, and the audience was told that participating in the memory test was optional, but that individual test scores would be provided anonymously at the end of the presentation. A statement outlining the subjects' rights was provided to all audience members on a written page and reviewed on a slide under a Protocol approved by Stanford University Institutional Review Board with no identifying information collected and no written consent required. The same 10-item practice test and 50-item memory test were used at all sites (2 individuals publicly acknowledged taking the test before, but were not identified). The VNBT was presented by projecting test items onto a screen using a laptop computer and projector. No effort was made to assess visual acuity of audience members or to assure adequate visibility from all parts of the room. The slides were generally easily seen from all vantage points of every room in which the test was administered. Participants were told that they would see a series of 50 pictures one at a time for 5 s per image (no inter-image interval). They were instructed to look at each picture carefully and any time they thought an image was repeated they should note the image number shown in the top left hand corner and immediately mark the circle corresponding to that number on their answer sheet. No response was required if they thought an image was not repeated (i.e., novel). The 10-item practice test was given first. The presenter then addressed any questions relating to the test procedure, and then the full 50-slide test was given (250 seconds). After the test, the participants handed their papers to the rater to be scored. A rater scored each participant's answer sheet, after which the scores were returned anonymously to each participant. If scores indicated a high probability of memory problems, a notation was made on the anonymous score sheet encouraging the subject to visit their clinician for further evaluation. It has been reported that about 50% of individuals receiving positive screens will accept such a referral. Results from the VNBT were analyzed using the correct and incorrect response information. The correct recognition rate (hit rate) and the false positive rate were used to determine a signal detection parameter, discriminability score (d′). The correct recognition scores included responses to only the first repetition of the items (n=14), while the false positive applied to all 25 items. A standard correction was necessary when calculating d′ values if the hit rate or the false positive rate were 100% or 0%. Following MacMillan and Creelman, we converted 0% to 1/(2N) % and 100% to 1−1/(2N) % where N=the number of items. VNBT scores were analyzed in two ways. First, the relationship between individual test scores (d′) and age was examined using regression analysis. Next, three-way univariate analysis of variance (ANOVA) was used to examine the effect of age, education, and gender on errors and d′ scores. To determine the effects of age on test performance, participants were divided into six age-groups (see Table 1). To determine the effects of education on test performance, participants were divided into five groups corresponding with major divisions of attainment in the U.S. educational system [i.e., <12 years (high school), 13-15 years (some college), 16 years (college completion), 17-19 years (Master's Degree) and 20-21 years (advanced degree)]. Significant effects were investigated using the Tukey Studentized Range/HSD post-hoc test procedure to identify homogenous subgroups.

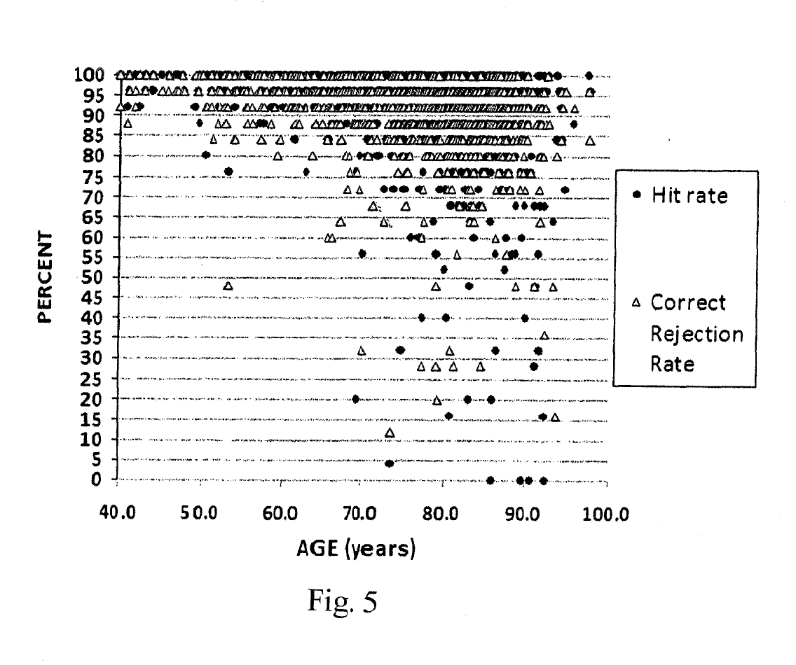

Referring to FIG. 5 increased age was associated with a significant increase in both miss rate and false alarm rate. The corresponding hit rates and correct rejection rates decreased with age as error rates accelerated in the oldest individuals with a non-linear relationship to age. Data were analyzed using nonlinear exponential and logarithmic data transforms. Error rates were found to be best explained using an exponential model (i.e., r2 of the regression was higher fitting an exponential transform than fitting a straight line). Regression analysis showed that miss rates increased significantly with age, exponential trend, F (1,866)=64.2, p<0.001; r2=0.069, beta=−0.02, constant=0.017, and likewise, false alarm rates increased significantly with age, exponential trend, F (1,866)=129.3, p<0.001; r2=0.130, beta=−0.026, constant=0.01.

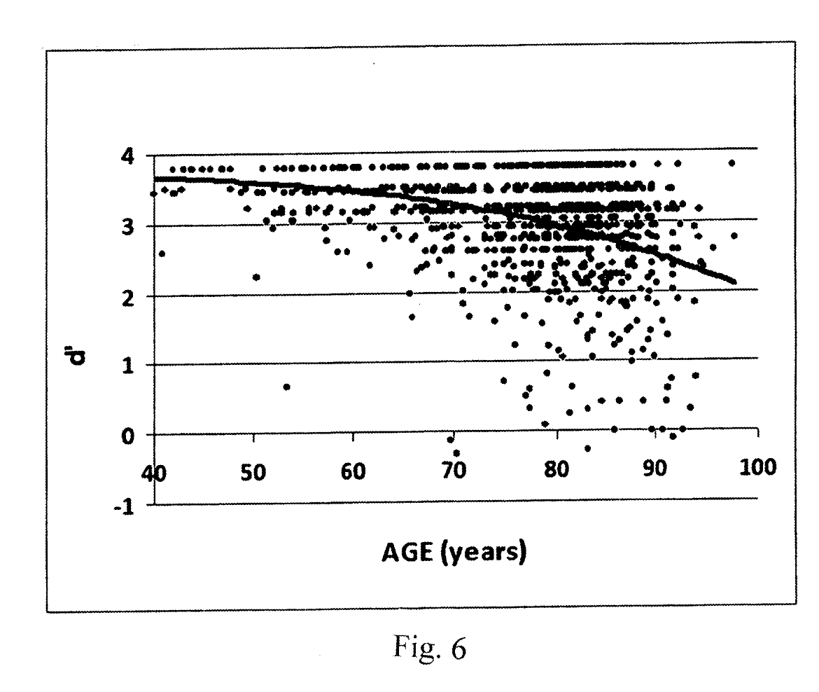

Referring to FIG. 6 there is a relationship between d′ values of individuals and their ages. Regression analysis revealed that test d′ scores decreased significantly with age, linear trend, F (1,867)=138.5, p<0.001; r2=0.138, beta=−0.026, constant=4.81. Data were also analyzed using an inversion of d′ scores (subtracted from the maximum value, 4), then regressed with an exponential model. This procedure explained the variance in the test scores better than a linear regression (r2 linear trend=0.138, r2 exponential trend=0.144), and regression analysis of the d′ inversion scores revealed that they decreased significantly with age with greater explanation of the variance than the linear model described above, exponential trend; F (1,867)=145.7, p<0.001; r2=0.144, beta=0.026, constant=−0.81. The 3-way ANOVA revealed significant main effects of age (F(5, 811)=12.97, p<0.001) and education (F(4, 811)=5.46, p<0.001) on VNBT scores. No significant effects were found for gender (F=0.62, p>0.05). No significant interactions were found between age, education, and gender (all Fs<1.2, all ps>0.05). For post-hoc test analysis, homogenous subsets were examined: six age groups by decade from 40 to 99 and the 5 education groups described above. Additional separate analyses for age were performed using participants having more than 12 years of education since there was no significant education effect noted above 12 years.

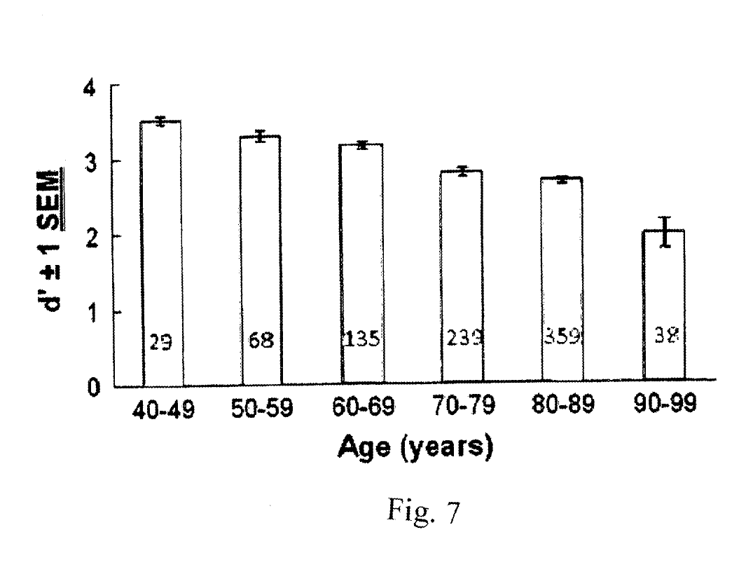

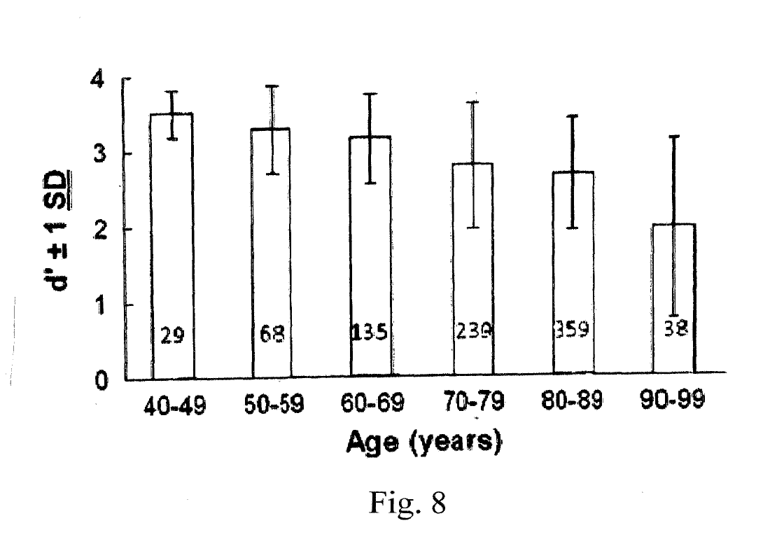

Referring to FIG. 7 in conjunction with FIG. 8 ANOVA results indicated that the VNBT was sensitive to age and was more difficult for older adults than younger adults. Again, age-associated effects were investigated further by examining the error rates: the missed items and the false positive rates that contributed to the overall d′ scores. Increased age was associated with significant increases in both the miss rate (F (5,867)=14.10, p<0.001) and the false alarm rate (F (5, 867)=13.96, p<0.001). Test discriminability gradually but significantly declined numerically with increasing age. Of note, the standard deviation of d′ performance increased progressively with increasing age. Although the IA six age groups did not differ significantly in number of years of education (see Participant section), it was noted that the oldest group also had numerically the lowest average level of education. In order to verify that the effect of age on the VNBT performance was not confounded by educational level, participants in the group with the lowest level of education (i.e., <12 yrs of education, n=82) were excluded in a secondary analysis. Results were essentially the same as when all participants were included. These data strongly indicate that test discriminability declined significantly with increasing age, F (5,785)=26.20, p<0.001. Again, increased age was associated with significant increases in both the miss rate, F (5,785)=11.48, p<0.001, and the false alarm rate, F (5, 785)=13.30, p<0.001. The post-hoc subsets consistently showed exponential declines of performance with age. To confirm this effect, data were further analyzed with post-hoc Tukey tests, which automatically correct for multiple comparisons. This analysis supported a significant decline in discriminability with increasing age. Significant differences in test scores were found between the following groups of participants: 40-59 years, 50-69 years, and 70-89 years. The group older than 90-99 years of age was significantly worse than all other groups. The miss rate was not statistically different within the groups with age range 40-79 years or 50-89 years, but showed a significant increase in the age group 90-99 years relative to the younger groups. False alarm rates showed a similar pattern and were homogenous within each of the following age ranges: 40-69 years, 60-89 years, and 90-99 years. When the individuals (n=82) with education less than or equal to 12 years were removed, the post-hoc tests showed that test performance expressed as d′ was similar across the age ranges 40-59 years, 50-69 years, 60-79 years, 70-89 years and 90-99 years. The miss rates showed a similar pattern as for the previous analysis and were not statistically different within the age range 40-89 years, but the age range 90-99 years showed a significant decrease relative to the younger ages. False positive rates showed a similar pattern to the previous analyses and were homogenous within each of the following age ranges: 40-59 years, 50-69 years, 60-89 years and 90-99 years.

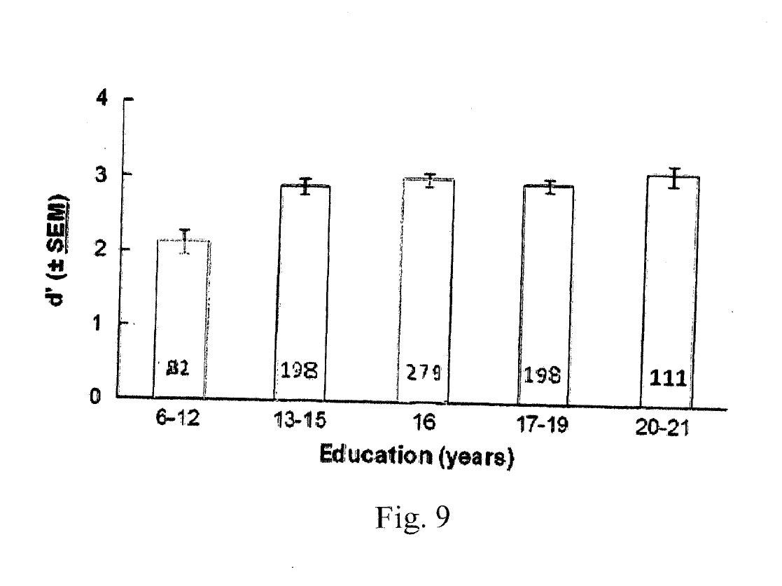

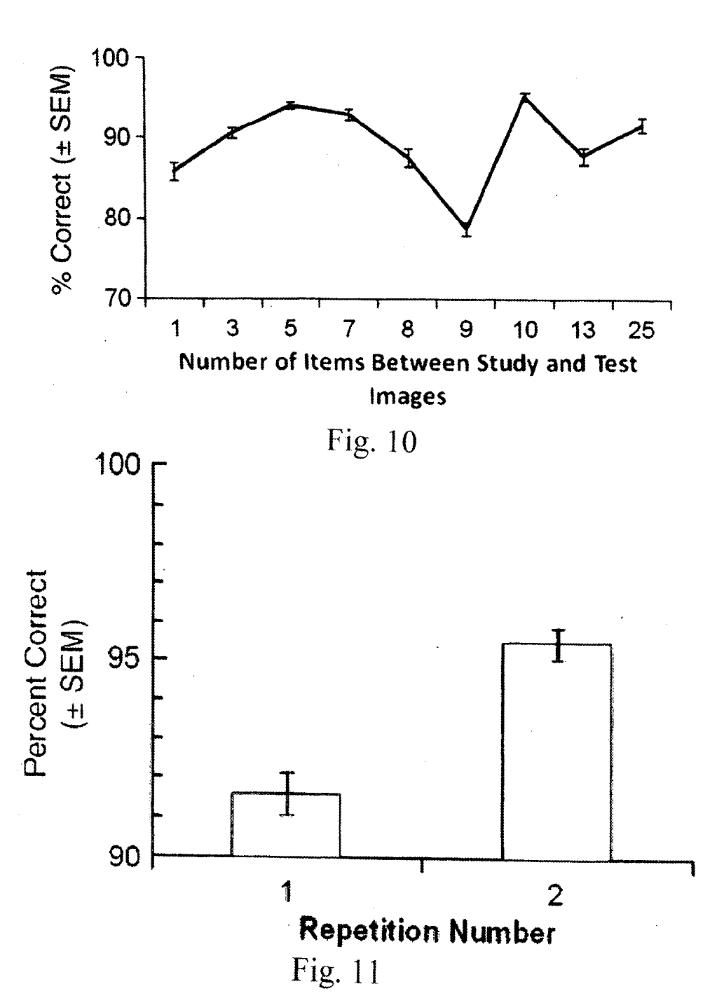

Referring to FIG. 9 there is an effect of education on test performance. Test performance was lower for those with education levels of 12 years or less relative to those with more education. However, performance reached a plateau after 12 years of education above which no significant improvement in performance was seen. Post-hoc tests showed that the test scores of the group with 12 years of education were significantly below all other groups (i.e., 13-21 years of education). A one-way ANOVA confirmed that the mean age did not vary significantly across the five education groups, F (4,867)=2.15, p>0.05. The lowest educational group (<12 years) was also numerically the oldest (79.5 years old vs. group mean of 76.4 years old for those with over 12 years of education), suggesting that levels of education vary systematically with age and the poorer performance of the lower education group may actually be due to an age effect. In order to demonstrate that the effects of education on test score were associated with low levels of education (i.e., <12 years of education), the analysis was repeated using only individuals having more than 12 years of education. This ANOVA showed that when individuals with low education were excluded, no significant effects of education on test performance were found, F (3, 785)=1.65, p>0.05. Due to the repeat-detection format of the VNBT, participants were required to hold items in memory for a variable delay.

Referring to FIG. 10 the inter-repetition-interval ranged from 2 to 25 images. This delay could disrupt recognition performance in two ways. First, as the number of intervening items increased, the time delay between the first and subsequent presentations of the same item could reduce recognition. Second, as other test items were presented during the time delay, interference could build up across the delay. To explore these effects, a linear regression analysis was performed between the number of intervening items and percent correct. No significant relationship was found between the number of intervening items and recognition performance, F (1,8)=0.10, p>0.05, r2=0.02, beta=0.12, constant=88.6. The inter-repetition-interval had little overall effect on recognition and performance was maintained at a high level across repeated items (average=89%).

Referring to FIG. 11 another issue related to the repeat-detection format is that when test items are repeated multiple times, each subsequent presentation serves as a retrieval cue to reactivate and strengthen the memory representation of the information stored during earlier study. In the current test, eleven items were shown three times, and recognition performance did increase across repeated presentations. A paired t-test compared the mean percent correct between the first and second repetitions and showed that this difference (91.6% vs. 95.5% correct) was statistically significant, t (867)=−10.30, p<0.005. The results from this study of community audiences show that memory can be measured in a large group setting. The decreased memory with age found in this study is consistent with the general pattern of age-related memory loss. The present study focused on memory for complex information retained after a delay. In this test, memory storage was assessed using a recognition format. The experience presented here with this VNBT indicates that it is feasible to test audiences of older individuals for recognition of this type of information. This VNBT provides a strong assessment of the type of memory, frequently referred to as declarative memory, which is impaired in Alzheimer's disease. Impairments in declarative memory are often found to be among the first symptoms during the progression from normal aging to Alzheimer's disease. The observation that declarative memory is selectively impaired early in Alzheimer's disease is consistent with the finding that the neurodegeneration associated with Alzheimer's disease begins in the medial temporal lobes, an area of the brain known to be important for encoding declarative memory. Further, several studies have suggested that the specific aspect of memory most commonly impaired in preclinical AD is a difficulty in encoding new information (Ashford et al., 1989 and 1995, and Ashford, 2008; Salmon & Bondi, 1999). This VNBT is well suited for measuring memory most relevant for the detection of the early memory difficulties found in Alzheimer's disease patients. Memory encoding can be tested in many different ways. Recognition memory is particularly suitable for the assessment of encoding as the target stimuli are given as part of the test materials. Recognition memory is less dependent on retrieval processes than are other commonly used testing formats such as free- and cued-recall. Impairment in recognition memory is evidence for impairment in encoding which raises the possibility of an emerging Alzheimer's process.

Referring again to FIG. 7 and FIG. 8 from the testing in the population examined by this study, the VNBT appears to measure learning across a broad range of memory abilities. The analysis of the standard error of the mean (SEM) and the multiple statistical analyses of education showed the sensitivity of the VNBT to age-related changes in memory. The VNBT test also showed a substantial increase in the standard deviation of each sample group with increasing age, and therefore, the VNBT provides limits for estimating the statistical variation that would be expected at various ages. After establishing the expected variation in memory function for a specific age, abnormal memory function levels can be defined for individuals of a specific age. In showing the capacity to assess memory deficits, the VNBT shows potential for detecting memory problems that are indicative of early signs dementia related to Alzheimer's disease or other disorders and could be used to screen populations for dementia. There are specific issues that must be addressed when considering a test for screening. Performances which are poorer than 2 SDs below the mean for any population may be defined as abnormal. Younger individuals (e.g., 40-50 years) with performance levels which are poorer than 2 SDs below the mean for this age group should definitely be considered to be of clinical concern. The problem is that low scores in older individuals may lie within 2 SDs of the mean for their own older age group, and thus would not be “abnormal”. A further consideration is below what absolute memory performance level might individuals of any age be at risk for having functional impairment? These are two different approaches to determining cut-off levels that might be considered when using a test for screening purposes. When developing a screen for memory problems, it is necessary to consider cost-effectiveness including consideration of the pathological entity targeted for screening. The decision about whether to screen an individual and the critical level for clinical concern depend on an analysis of many factors. The factors to consider for such an analysis include: incidence of disease; the benefit of a true-positive screen; the cost of a false-positive screen; the incidence of the target problems in the population; and the cost of the test (Ashford, 2008). A large factor in the decline of memory performance with age is likely to be the exponential increase of dementia incidence. The value of using a particular level of test performance as a positive screen for an individual is approximated by a cost-worthiness analysis. This approach is more difficult than a simple cut-off value for screening as described above, but is better for addressing clinical needs. The VNBT may be useful for detecting memory problems related to a variety of disorders. It is unclear whether the alterations in memory associated with early Alzheimer's disease are different from those associated with age-related changes in memory. Alzheimer's disease itself may be a complex interaction of at least two pathological processes (amyloid-opathy and tau-opathy), which have different time-courses and roles in different aspects of memory impairment that are otherwise considered “normal aging”. For proper screening of older individuals for cognitive impairment, more issues than just memory performance need to be considered. Performance levels on a test like the VNBT could be monitored over time to detect indicative of a progressive cognitive disorder. An important issue for this VNBT is that the test is “fun” so that individuals may be willing to take the test repeatedly. Changes over time should be assessed with respect to age-cohorts since normal performance levels and changes over time do vary according to age. Of note, the pattern of memory deterioration with age was best fit by an exponential model, suggesting that the underlying aging physiology follows the Gompertz Law, which states that the rate of system failures increases exponentially with age, in this case, the failure of mechanisms subserving the performance of this memory task. The VNBT is not affected by education level beyond high-school, probably because the memory processes targeted by this test require relatively simple object-information storage and processing, similar to what laboratory animals can be trained to do. Education appears to have at most a minimal effect to confound assessment. Subjects with a high-school education or less performed significantly less well, and there needs to be further study of individuals with low education on this test. Another issue is how effective is the VNBT for assessing information encoding? It is well established that there are significant declines in delayed-recall performance as individuals get older. Much accumulated data indicate that these differences pertain to the fact that it takes older individuals longer to learn new information (encoding), but once learned, it is retained well over numerous delay intervals. If one compares the decline on recall scores from immediate to delayed recall, there are no statistically significant age-related differences. If one allows healthy older subjects to learn material well to the point where few errors are made, they do not forget what they have learned more rapidly than the young. If healthy older subjects are not given the ability to learn material to the same level of proficiency as younger individuals, after a delay, less information on average will be retained by the older person. Based on these prior findings, there is a question about whether older individuals may have performed better if the stimuli were presented for a longer period of time more than 5 seconds per image. Widespread individualized testing of older subjects to screen for memory difficulties has not been practiced in the past. However, it is important to screen older people for memory problems that may indicate dementia. While screening tests are widely used throughout Medicine, they are not yet recommended for dementia or Alzheimer's disease, and this lack of recommendation is based in large part on the lack of an easily administered and validated screening tool. The VNBT test presented here could be developed to serve this important need. Clinically, any screening test must be seen as a preliminary assessment and definitely not a diagnostic test. The use of a test to screen for memory problems is appropriate. The VNBT approach offers a process that can be adapted for many settings and cultural milieus. In summary, a brief, easy to administer test for audience or large-population administration was found to have significant sensitivity to the changes in memory accompanying normal aging and could form the basis of a screening system to detect memory problems indicative of clinically significant memory disorders. Since the VNBT measures the type of memory most affected in early Alzheimer's disease, this test could serve as a practical approach to screen for early dementia associated with Alzheimer's disease. Further development and study of this type of testing and population assessment is warranted. This specification also provides for the presentation of visual stimuli (pictures or words) using a computer: A specific test is defined by its instructions which appear on a specific image file (the “instruction sheet”). The stimuli are specifically referenced by a file (the “images index file”, which is stored in a specific directory, e.g., (sets) which indicates the address locations of the stimuli. The order of the stimuli is specified by a second file (the “order file”, which is stored in a specific directory, e.g., Osets). The stimuli are presented in the order specified by the “order file”. The duration of stimulus presentation is set for a specific test administration. (OPTION) the stimulus presentation duration for an individual subject can be set for a specific individual and can be set to vary during the administration of the test according to the performance of the subject. Responses may consist of a single indication from the subject taking the test and may include the press of a key (e.g., the “space bar”), any other similar response or measurable movement, or an utterance (detected by a microphone). (OPTION) secondary responses may be instructed for indicating that the subject decides that the displayed image is new, using a different indicator (e.g., left-arrow for old versus right-arrow for new) and reaction time to the second indicator may be measured as well. The computer detects the responses (or lack of responses to a specific stimulus within a certain period of time) and records the reaction time with millisecond precision for each stimulus presentation. The reaction time (response data) from each individual stimulus presentation is recorded for subsequent analysis. If a reaction is indicated within the observation window, the precise reaction time is recorded. A response is a reaction time within the observation window and is correct or not according to the instructions specified for the test. Analysis of the data for presentation of summary results can occur immediately following the response (or lack of response) to the last stimulus or may be done at any later time. The platform administering the TEST (computer program, slide-show) may also be used to show tests for: Simple reaction time (the image set is a single content image and blank image, or a series of images, with the order set indicating that correct response is responding to the content image—or blank image, depending on the cognitive function being assessed). Choice reaction time (the picture set contains two or more content images, and the order set indicates that a response is required only for a specific image or defined set of images. Alternatively, if two types of response can be made, alternate responses may be instructed as correct for each of the images or defined sets of images. The “Super-Simple” Reaction-Time Test (a test developed by Dr. Ashford in 1986 that has the response instruction included in the stimulus itself, e.g., an arrow indicating which way to respond.)

N-back Attentive Memory (1-back, 2-back, or 3-back: in this well-established testing paradigm, the correct response is to the repetition of an image shown 1, 2 or 3 images before the most recent image. This paradigm is a test of Attentive Memory”.

Continuous Performance Task (In this well-established paradigm, a series of images is shown with a rare target image occurring which requires a response. This paradigm is a test of General Attention). These ancillary tests may be used for determining impairment of a variety of cognitive functions. In many patients with mild cognitive impairment or mild dementia, only retentive memory is impaired and other tests of cognition are preserved. A computerized test may include a tapping speed test, which can also help to determine if the subject's movement functions are in the normal range. This information can be used in adjusting the interpretation of the reaction-times measured in the test, to distinguish the component of the speed related to movement function from the component related to cognitive function. Images may be complex pictures that can be easily named or not named. Images may also be words that are easily visualized as nameable objects or not easily visualized (abstract, emotional, complex). The working model for the Memtrax Memory Test uses picture images in which there are 25 new pictures and 25 repeated pictures. For each set of pictures, there are 25 total pictures divided into 5 bundles of 5 pictures. All pictures are from real, color photographs, no black & white, no line drawings, no sketches. The 5 bundles are selected to follow these categories:

A) Abstract, difficult to name, still-life, landscape, rocks and minerals;
B) Buildings: houses and shelters;
C) Clothing: hats, shirts and apparel;
D) Female oriented: kitchen ware, sewing items and furniture.
E) Male oriented: trucks and tools.

For these bundles, there are 5 categories that have been developed:

A) Nature: landscape, rocks, minerals, water, flowers, difficult to name.
B) Buildings: houses, barns, fences, walls, windows, outdoor items.
C) Clothing: hats, shirts, belts, apparel, functional jewelry.
D) Kitchen, household: utensils, cups, bowls, furniture, sewing items.
E) Machinery: vehicles (trucks, boats), tools, equipment. There are sub-categories under each category, then groups of 5 pictures under each sub-category. Among each group of 5 pictures, there are 2 items that are slightly similar, while the rest are easily perceived to be different.

There are no people, no animals, and no writing/lettering, with a general avoidance of inanimate animals and statues. There are no emotion-generating pictures, such as food, expensive jewelry, weapons, sexual material, burning, gruesomeness and gore. There are no pictures that would immediately be recognized by more than 10% of the population (Golden Gate Bridge, Taj Mahal and pyramids—note that these items could be used in alternative tests, but not a test focusing on objective, non-emotional memory). Photographs of paintings or complex pictures are generally avoided, though they could be under the abstract bundle. Unique cultural items are generally to be avoided, but can be selected for specific populations, following the same rules (e.g., Chinese dishware and furniture has been used for a presentation to be given in China). These exclusions only apply to a version of the test for preliminary screening of older individuals for memory dysfunction. The excluded categories may be used for evaluating memory in younger individuals or specific areas of deficits in individuals of any age. Order definition is the number of single, double, or higher repetitions, can be specified to modify test difficulty. The pictures vary in color, and background color should have some variation. However, the pictures are clearly distinguishable independent of color. The pictures should be clear. They may be 20-80 K JPEG images—medium resolution, 320.times.240, with good quality and no noticeable pixilation. A high resolution version of the images of 640 times 480 or higher is permissible if the computer capacity is feasible for rapid down-load of the images and perceptually instantaneous presentation of each image. There can be several bundles that are similar, but not so similar that they can be confused from day to day across 20 image sets. Pictures should be named by convention, A-E; category, sub-group, number, example of name: A-WaterFall-01.jpg. There are five categories of bundled items and examples of groups of five are as follows:

A) Nature: landscape, rocks, minerals, water, flowers, difficult to name.
B) Buildings: houses, barns, fences, walls, windows, outdoor items.
C) Clothing: hats, shirts, belts, apparel, functional jewelry.
D) Kitchen, household: utensils, cups, bowls, furniture, sewing items.
E) Machinery: vehicles (trucks, boats), tools, equipment.

Among these 5 bundles, more specific descriptions are: A) Nature: landscape, rocks, minerals, water, flowers, difficult to name are interesting rocks and minerals, landscapes including vistas and forests, waterscapes including lakes, ocean, rivers and waterfalls, flowers and flower arrangements. Among buildings are houses, barns, fences, wall, windows and outdoor items, outdoor ornaments. Among clothing are hats, shirts, belts, apparel and functional jewelry. Among apparel are shirts, socks, shoes, slacks and blouse. Among accessories are hats, belts, scarf, mittens, gloves and canes. Among kitchen and household items are utensils, cups, bowls, furniture and sewing items. Among kitchen wares are glass bottle, pots/pans, mugs, bags, champagne/wine glasses, crystal wares, sewing items, buttons, Jewelry (not stunning), hair items, Furniture: Desks, Chairs, Tables: side, end, coffee, dining, Chandeliers, lamps, Door knobs, Machinery: vehicles (trucks, boats), tools, equipment, Automobile/parts: Tire treads, Trucks, tractors, Ships, boats, Tools, Electronic Equipment: Speakers, Bells, and keys.

The following is an example of an order of the 50 images include 25 new pictures (NEW) and 25 old pictures (OLD) that has been implemented in several computer platforms and an audience presentation platform. Rules are adapted from Gellerman, L. W. Chance orders of alternating stimuli in visual discrimination experiments. Journal Genetic Psychology, Volume 42, pages 206-208 (1933). No more than four images of a specific type, NEW or OLD, occur together. No more than four alterations in a row (NEW, OLD, NEW, OLD). First 2 items are NEW. Last 2 items are OLD. In first 10 items there are 7 NEW items and 3 OLD items. In last 10 items there are 3 NEW items and 7 OLD items. In the middle three groups of 10, there are 5 NEW items and 5 OLD items in each group. Twenty images are repeated once, 5 images are second repeats, and 5 images are not repeated (2 in last 10, and 1 in each of the middle 10). Orders of the items from the 5 bundles (all from a single sub-group within each bundle) are within the 50 image presentations. One of each of the 5 bundles must appear as a NEW in the first 10 images. One of each of the 5 bundles must appear as an OLD in the last 10 images. For each of the 5 bundles, there must be one item for which the OLD item occurs at least 20 items after the NEW image. Each bundle has one item which is repeated after just one intervening stimulus. There are no adjacent images from the same bundle. Each bundle has one item shown 3 times (NEW, OLD, OLD), with n the second old stimulus occurring after at least 10 intervening items. Each bundle has one item which is not repeated.

The Algorithm for Computer Program includes showing loading-progress indicator if more than 5 seconds for loading is possible, establishing Fixed Variables (may be varied): a. Length of permissible reaction time, shortest, longest (example for complex images: 150 to 2900 msecs) b. Time for showing new images (start with 3 seconds), loading Instruction Set, Image Set (sub-directory “Isets”), Order Set (sub-directory “Osets”), loading Images (according to locations identified in Image Set), pre-loading Images for display, beginning client interactions—ask for indication of agreement with license, showing instruction that ESC key may be pressed to end test at any time entering “FULL SCREEN MODE,” showing Instructions, request SPACE-BAR-Press to begin test and entering Display-Response Routine which include select image for next display, note computer time in milliseconds=start time, display image, display time=computer time-start time, monitor either keyboard for key press or touch screen for touch, if ESC key is pressed stop, query about restart with different test or if non-SPACE-BAR is key pressed, wait for full allowed time to exit, if acceptable key board press, response time=display time, if too short, wait for full allowed time to exit wait routine 2, if permissible time (e.g., 3 seconds), exit wait routine, monitor display time, if display time less than allowed time, go to “d”, display time. if display time greater than or equal to allowed time, exit wait routine 11, exit display-response routine, check performance of subject (note option to change image display time), check image number a, if image number=50, continue b, if image number<50, go to #10, Display-Response Routine 14), calculate performance of subject based on Order Set and Response Times 15), (OPTION) display data to subject. 16) Stored Data (may send to server) Offer choice to end program or continue with new process. Computer programs in which the TEST has been Implemented: Prototypes of the TEST have been written in HTML-Javascript, JAVA, FLASH or PHP The test has been given in several versions as a PowerPoint presentation, to over 2000 individuals. Screening for memory problems, particularly those associated with dementia and Alzheimer's disease, has presented a significant logistical problem. The currently available memory tests are time-consuming and generally must be administered by a psycho-metrician in a one-to-one interaction with a participant in a confidential and quiet environment. Such tests must trade duration and participant burden with poor accuracy and a low ceiling effect making assessment of normal individuals problematic. There is a need for a simple, accurate memory test that can be administered in a group setting that is feasible for testing older individuals. The MEMTRAX Memory Game was adapted to a slide show format and an approach reminiscent of college aptitude testing for a large group. Over the course of two years, this format was used over forty times at various community events, senior citizen centers, and retirement living communities, with over 1500 participants tested. Between Jul. 1, 2007 and Jun. 30, 2008, the test was administered at 26 sites using a single sheet, demographic information on one side and on the other, an answer sheet on which participants could indicate recognition of repeated pictures, in a format that could be scanned for data entry and analysis. The answer sheet had pre-assigned identification numbers and columns with numbers and single adjacent circles. Participants were shown a series of numbered slides, 5 seconds for each. Participants were asked to fill in the circle next to the number on a repeated slide. After a brief introduction and a short practice test of 10 slides, the participants completed a 50-slide test, that had 25 unique pictures, 15 repeated once, and 10 of those repeated a second time. After the test, the participants handed their papers to the rater to be scored. While the rater scored each participant's answer sheet, a presenter answered audience questions, after which the scores were returned anonymously to each participant under a protocol approved by Stanford University Institutional Review Board. Data were obtained on 1063 participants at the 26 sites (average 41 participants per site, range 8 to 142), mean age (for 697 participants) was 74.5+14.5 years, range 20 to 95, with 41 participants over 90 years of age and 52 participants less than 50 years of age. For individual participants, test results were scored as the overall percent correct, the number of false-positive errors, and the number of false-negative errors. Of 708 scored tests, 540 participants (76%) scored 90% correct or better, with 48 participants (7%) having perfect scores and only 8% scoring below 80% correct. There were 67 participants (10%) who had more than 5 false-positive errors (incorrectly indicating an image was a repeat), while the same number of participants, 67, had more than 5 false-negative errors (failure to recognize a repeated picture). Performance on individual images was also analyzed. Of the new images, 2 were missed 64% and 58% of the time (false-positives), with 7 being missed between 5% and 27% of the time (all in previously shown categories), and the remaining 16 of the new images were missed less than 5%. Of the repeated images, 2 were missed 33% and 20% of the time (complex images) and all the rest were missed 16% or less. Only 3 repeated images were missed less than 5%. Thus, the repeated image errors showed less variability than the variability of the errors on new pictures. These results suggest that particular items triggered false recognitions, but recognition failures occurred more uniformly across pictures. The effects of age were also analyzed. Percent true negatives decreased from 95% at age 50 to 85% at 95 years of age. Percent true positives decreased from 100% at age 50 to 80% at age 90 years. There were statistically significant associations of performance with age. While the accuracy, reliability, and validity of this testing format has not been conclusively determined, generally, participants getting more than five false-negative responses are of concern for the presence of Alzheimer's type dementia and those getting more than five false-positive responses are suspected of having problems with attention or disinhibition suggestive of fronto-temporal dementia. The MEMTRAX slide-test is not reliable for those participants with visual impairment or problems limiting their ability to fill in a circle with a writing implement. The experience with this format is that it is well accepted by audiences and has the potential to provide highly accurate and cost-effective screening for memory problems. In an era of increasing pressure to detect and manage prevalent disorders as early in their course as possible, screening has become an accepted norm for many conditions. If medical professionals and the public accept screening for hypertension, diabetes, breast cancer, and colon cancer, why is there no widespread demand to screen for dementia? Detection of dementia—the most disabling common condition of later life—is currently left to chance. Numerous approaches have been advocated to screen for memory problems, dementia, and Alzheimer's disease. Most of the approaches involve direct testing of potential cases or questioning of reliable sources (case-finding). Many of the tests have poor sensitivity and specificity for dementia, are cumbersome to administer, and are generally unpleasant for the patients. There is a clear need for a screening system that is attractive to prospective users, both patients and clinicians, which can provide reliable information, including baseline evaluation and frequent repetitions. By focusing on memory function, a screening test can address the issue most important for recognizing the earliest indications of Alzheimer's disease, new-learning memory difficulties. Visual information provides an essentially unlimited challenge to the brain's memory storage mechanisms. Performance information can be used to determine when further testing is appropriate. The purpose of this presentation is to report on the experience with a computerized memory test system that was adapted to a Power-Point slide presentation to be administered to a group of subjects. Results are presented from administrations between Jul. 11, 2007-Aug. 14, 2008. The principle psycho-pathological factor in Alzheimer's disease is n the attack of the formation of new memory traces that can be retrieved after distraction. Recall of learned words after an interval is the earliest problem seen in Alzheimer patients. This process is commonly tested using several different memory challenges. Providing complex stimuli that are easy for a normal person to remember would provide the most effective test for the Alzheimer process. MemTrax was developed based on the concept of providing a large volume of easily remembered information to a subject, then testing the recollection. The format used is referred to a “long-N-back” paradigm, with multiple complex visual stimuli, based on work by Shepard, 1961. Generally the images are of discrete objects, though similar objects and difficult to name objects were used to avoid strict reliance on verbal cues and to provide a challenge and maintain the interest of the subjects. The initial paradigm used a computerized administration format and then a web-based format. However, due to the difficulty in getting older individuals to participate in web-based games, particularly those individuals with mild cognitive problems, the MemTrax game was reformatted to a PowerPoint slide show, running automatically with 5 seconds presentations for each stimulus. 25 discrete objects are shown, with 20 of them repeated, 5 repeated a second time, making a total of 50 objects, requiring 250 seconds to display. The audience is given a formatted answer sheet and instructed to fill in the circles next to the numbers on the images which are repetitions. The MemTrax test has been under progressive development since 2000. The current version was given between Jul. 11, 2007-Aug. 14, 2008 on 26 occasions to senior citizen groups and health-fair participants, with a total of 1018 subjects filling out the questionnaire and submitting it for scoring (at most venues, a few subjects watched without taking the test or did not hand in their answer sheet, but no count was made of these individuals). There were an average of 39 subjects completing the form at each site (range 9-142, stdev=34). Data were entered with a scanner into a spread sheet format (REMARK software and EXCEL spreadsheet, results triple checked by hand). Analyses were computed from the EXCEL spreadsheet, which was also used to produce the graphs. Data entered as of Dec. 2, 2008-1018 individuals from 26 sites collected and considered that the individual had been able to perform the test with 805 having reported being “white”. 31<40y/o. Of the 1018 individuals that were considered to have taken the test in a fashion that could be scored (about 20 were eliminated, 31 were below chance (12/25 or less) on the true negative or true positive score (True−:3 males, 10 females True+:8 males, 11 females) (not included in graphs. Of these 1018 individuals, those scoring less than 80% correct for True−, 19 males, 51 females; for True+, 25 males, 54 females. Of these 1018 individuals, those scoring better than 80% for True−, 276 male (93.6%), 602 female (92.3%); for True+, 270 male (91.5%), 598 female (91.7%). Only 82 subjects had perfect scores, 230 made 1 error, 700 made 5 or fewer errors (about 70%), and 132 made 6-10 errors. Plots are shown for the 858 individuals with age, gender, ed data, red is first presentation, green is repeat, males in blue, females in pink. Performance on new images (True−) was more variable than performance on old images (True+). There is minimal difference in performance of individual items between males and females, in spite of significant “male-role” and “female-role”items. There is a significant decline of function with age, with the age-effect best explained by an exponential increase of errors with age (“Failure Theory”). Females had a greater association of false-positive errors with age than males, while the false-negative error association with age was similar by gender. Education was not significant in performance. MemTrax is a brief, convenient, fun test of the type of complex memory affected by Alzheimer pathology. Recognition failure (False−) indicates failure of learning circuits—typical of Alzheimer's disease. False-recognition (False+) responses are indicative that the subject is not paying attention and is failing to inhibit the recognition response, thus more suggestive of other types of psychopathology, including fronto-temporal dementia. MemTrax can test many levels of memory impairment accurately, validly, and reliability. Alzheimer's disease is not a dichotomous diagnosis but a continuum of impairment best assessed probabilistically using Item Response Theory (Modern Test Theory.

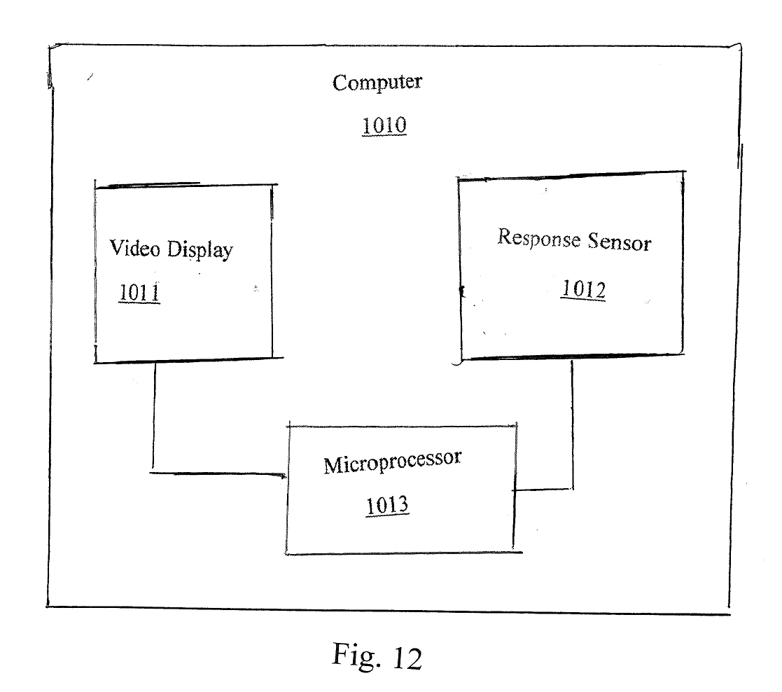

Referring to FIG. 12 a first computer 1010 has a first video display 1011, a first response sensor 1012 and a first microprocessor 1013. The first response sensor 1012 may be a particular key on a keyboard, the space-bar, a screen-touch mechanism on the first video display 1011 or a sound receiver for picking up an oral response.

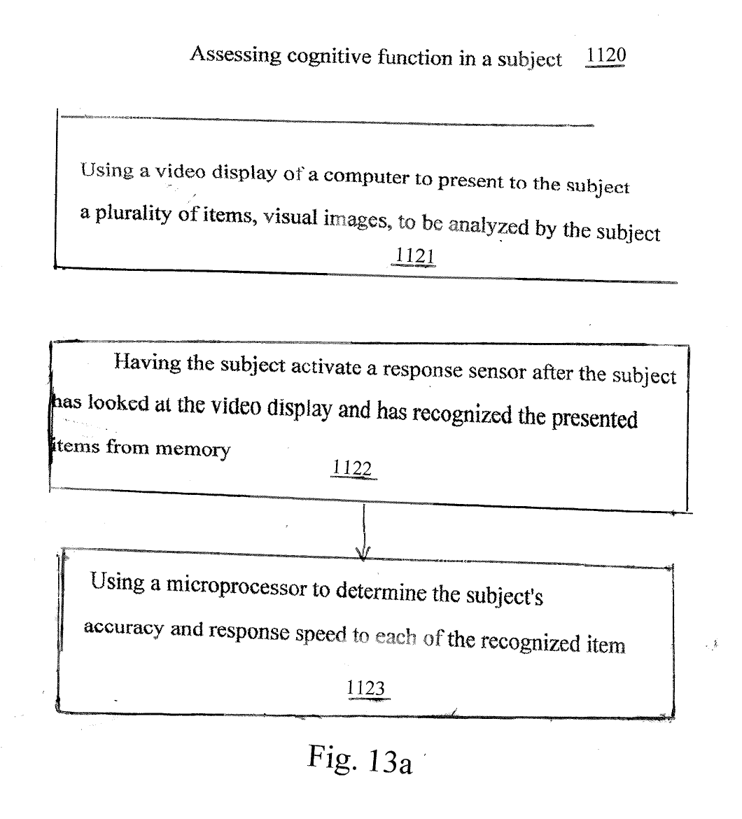

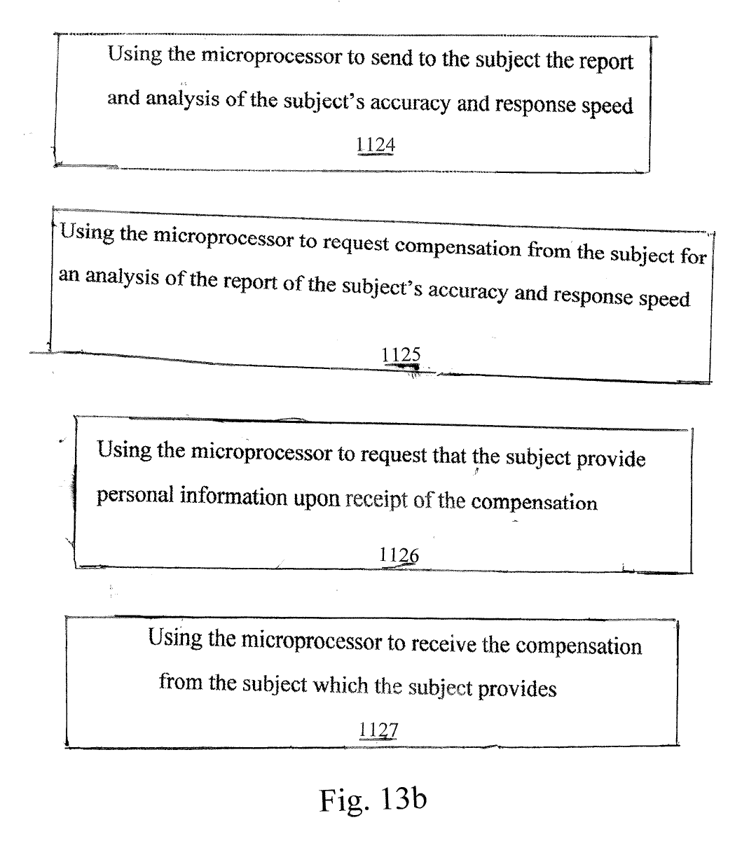

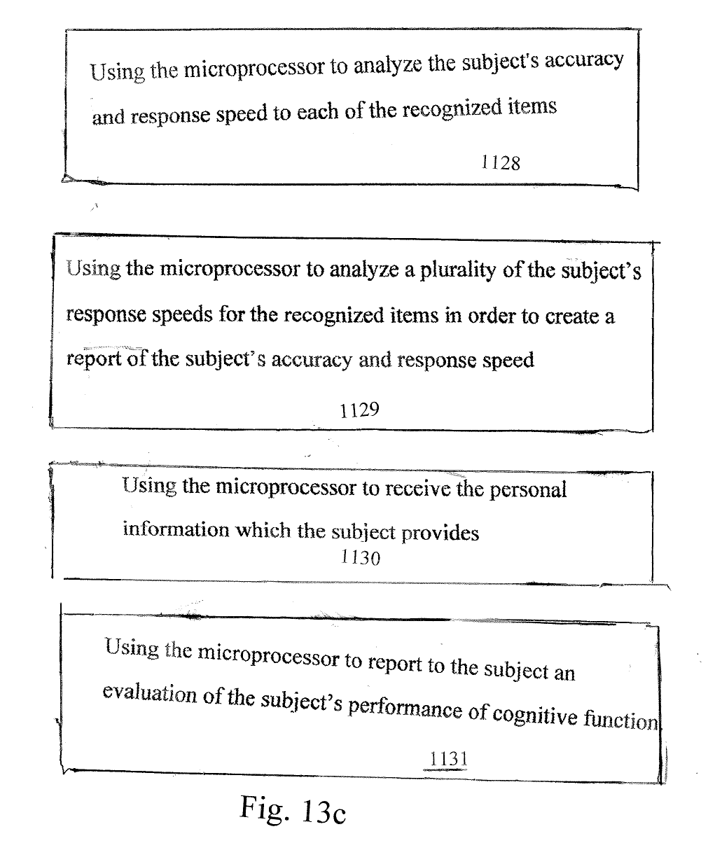

Referring to FIG. 13 in conjunction with FIG. 12 a method 1120 for assessing cognitive function in a subject includes the step 1121 of using the first video display 1011 of the first computer 1010 to present to the subject a plurality of items, visual images, to be analyzed by the subject. The items presented to the subject are intermixed with other of the items being tested for recognition. The method 1120 for assessing cognitive function in a subject also includes the step 1122 of having the subject activate the first response sensor 1012 after the subject has looked at the first video display 1011 and has recognized the presented items from memory. The subject is tested to determine if the subject recognizes each of the items as meeting specific criteria which the subject does by activating the first response sensor 1012. The method 1120 for assessing cognitive function in the subject further includes the step 1123 of using the first microprocessor 1013 to determine the subject's accuracy and response speed to each of the recognized items. The response speed for each of the recognized items is the time required between when the subject is shown an item and when the subject correctly responds that the subject recognizes the item. The method 1120 for assessing cognitive function in a subject still further includes the step 1124 of using the first microprocessor 1013 to analyze a plurality of the subject's response speeds for the recognized items in order to create a report of the subject's accuracy and response speed and the step 1125 of using the first microprocessor 1013 to send to the subject the report and analysis of the subject's accuracy and response speed. The method 1120 for assessing cognitive function in the subject also further includes the step 1126 of using the first microprocessor 1013 to request compensation from the subject for an analysis of the report of the subject's accuracy and response speed, the step 1127 of using the first microprocessor 1013 to receive the compensation from the subject which the subject provides, the step 1128 of using the first microprocessor 1013 to request that the subject provide n personal information upon receipt of the compensation, the step 1129 of using the first microprocessor 1013 to receive the personal information which the subject provides, the step 1130 of using the first microprocessor 1013 to analyze the subject's accuracy and response speed to each of the recognized items and the step 1031 of using the first microprocessor 1013 to report to the subject an evaluation of the subject's performance of cognitive function.

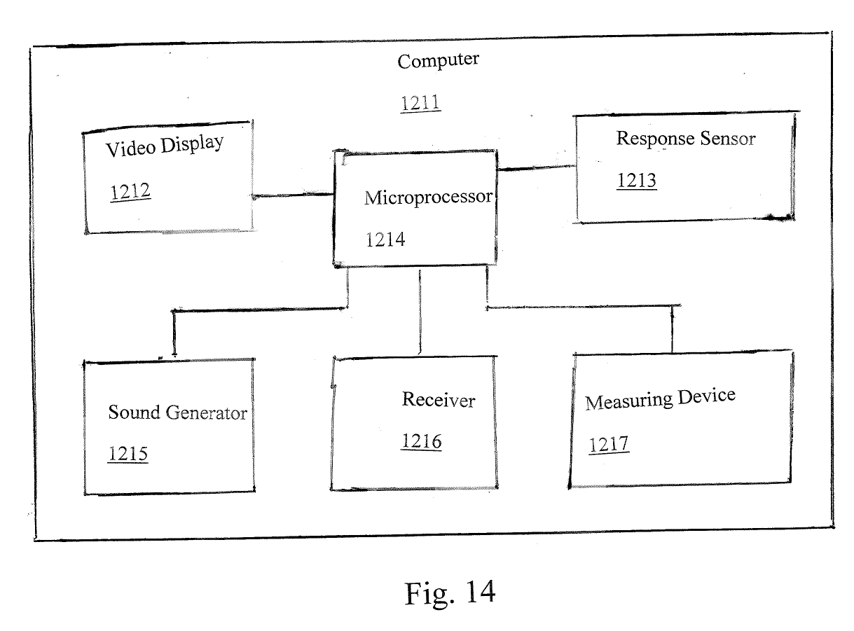

Referring to FIG. 14 an existing mental impairment determination system 1210 determines the presence of a mental impairment. The existing mental impairment determination system 1210 includes a second computer 1211 having a second video display 1212, a second response sensor 1213 and a second microprocessor 1214. The temporary mental impairment determination system 1210 also includes a sound generator 1215 which generates a stimulus in the form of a sound to be heard by a subject, a receiver 1216 which receives a vocal response to the stimulus by the subject and a measuring device 1217 which measures the speed and accuracy of the vocal response in order to determine the mental function and the presence of mental impairment of the subject for the ability to safely operate machinery. The sound may be verbal or non-verbal.

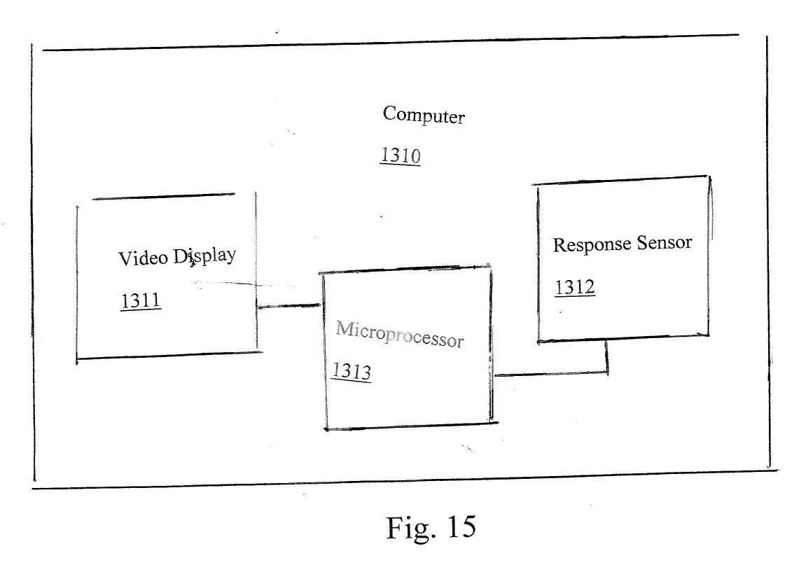

Referring to FIG. 15 a third computer 1310 has a third video display 1311, a third response sensor 1312 and a third microprocessor 1313. The third response sensor 1312 may be a particular key on a keyboard, the space-bar, a screen-touch mechanism on the third video display 1311 or a sound receiver for picking up an oral response.

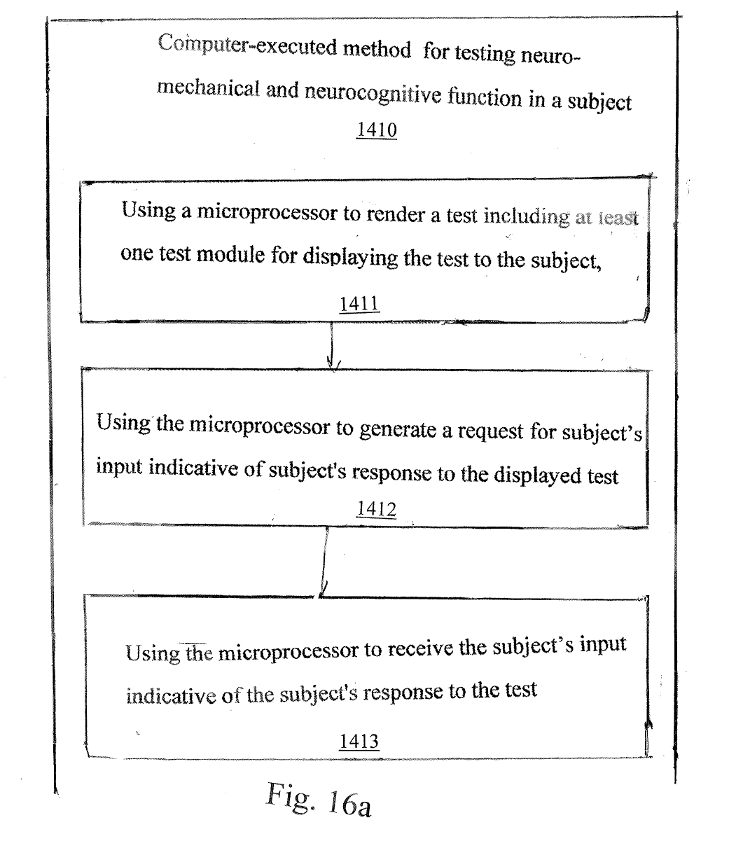

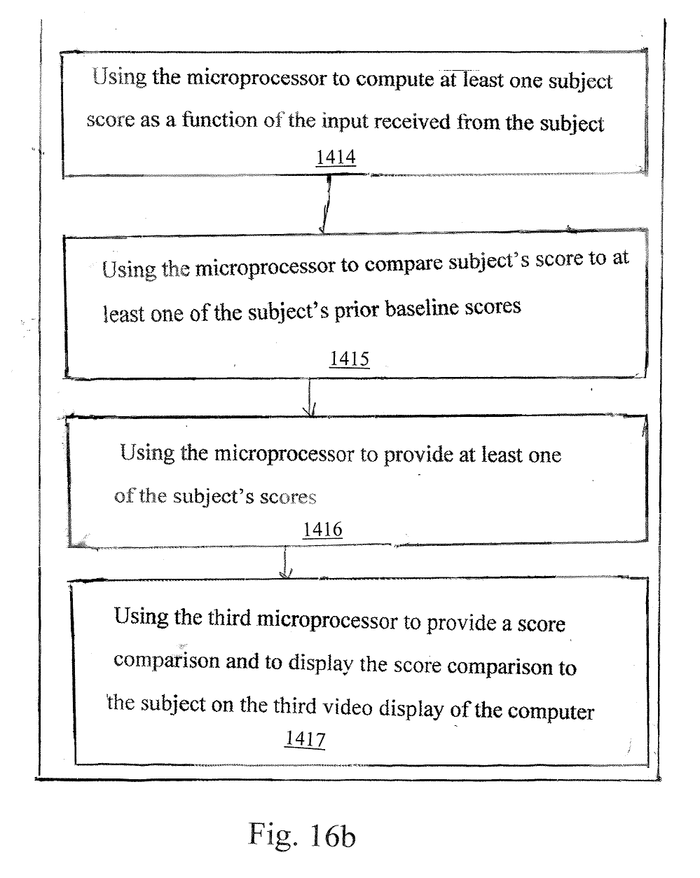

Referring to FIG. 16 in conjunction with FIG. 15 a computer-executed method 1410 for testing neuro-mechanical and neurocognitive function in a subject for use with the third computer 1310. The computer-executed method 1410 for testing neuro-mechanical and neurocognitive function in the subject includes the step 1411 of using the third microprocessor 1313 to render a test including at least one test module for displaying the test to the subject, the step 1412 of using the third microprocessor 1313 to generate a request for subject's input indicative of subject's response to the displayed test, the step 1413 of using the third microprocessor 1313 to receive the subject's input indicative of the subject's response to the test, the step 1414 of using the third microprocessor 1313 to compute at least one subject score as a function of the input received from the subject and the step 1415 of using the third microprocessor 1313 to compare subject's score to at least one of the subject's prior baseline scores. A subject's baseline score includes a mean score and a standard deviation computed from a plurality of the subject's scores obtained from previously completed tests by the subject. The computer-executed method 1410 for testing neuro-mechanical and neurocognitive function in the subject also includes the step 1416 of using the third microprocessor 1313 to provide at least one of the subject's scores and the step 1417 of using the third microprocessor 1313 to provide a score comparison and to display the score comparison to the subject on the third video display 1311 of the third computer 1310.

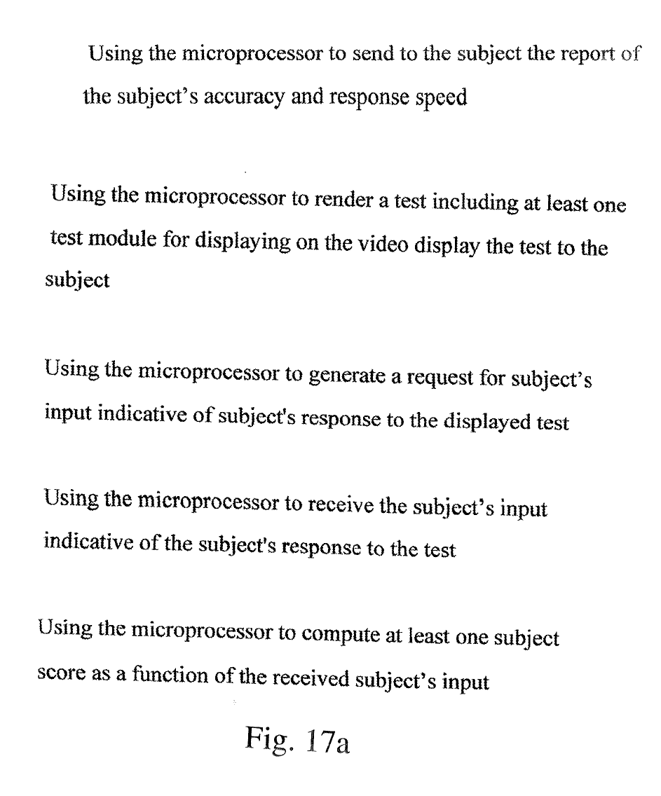

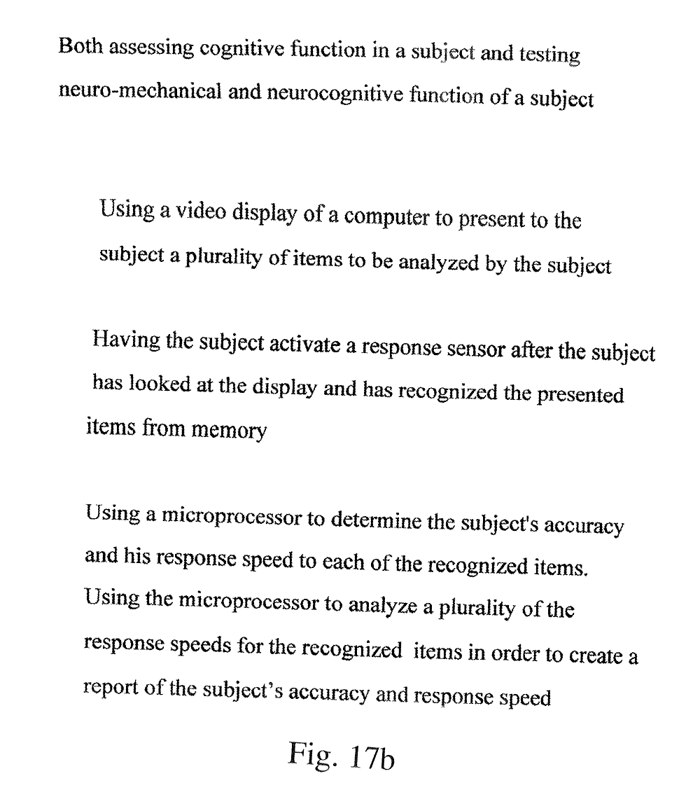

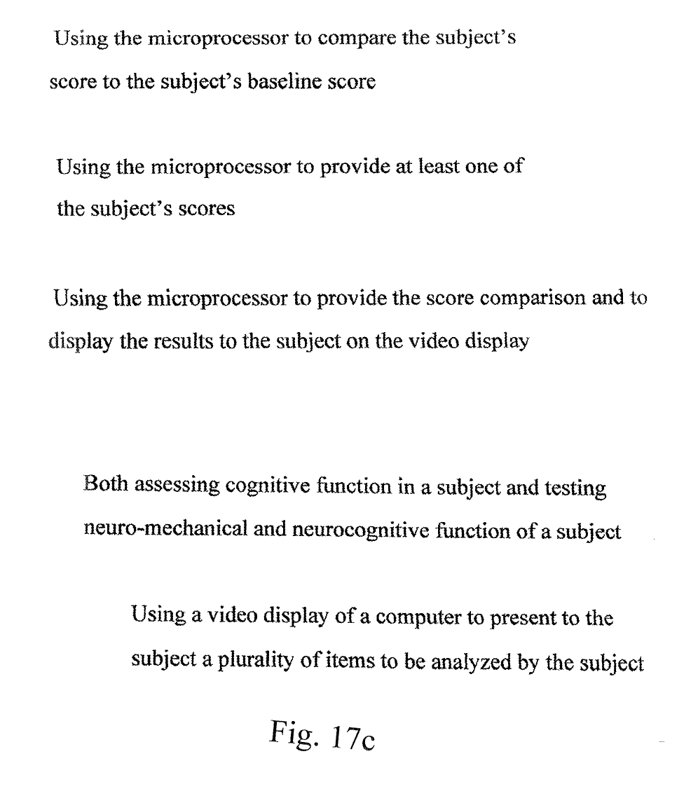

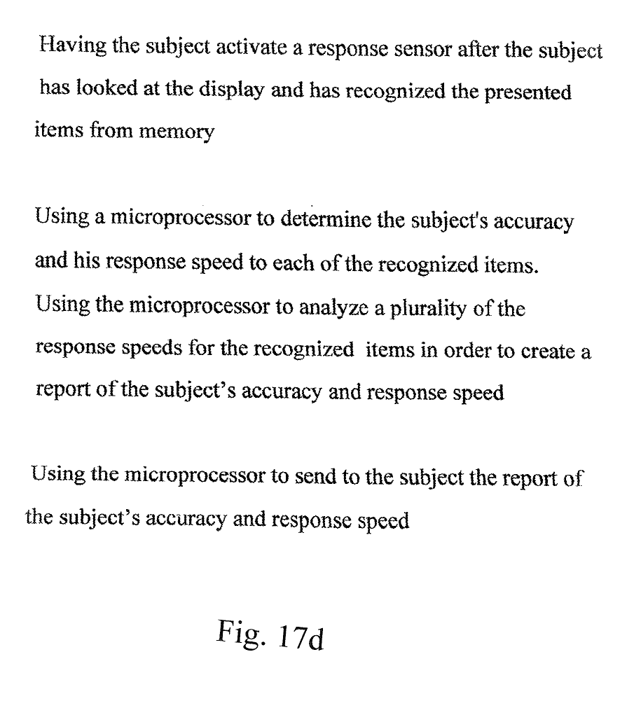

Referring to FIG. 17 in conjunction with FIG. 15 a method 1510 for both assessing cognitive function in a subject and testing neuro-mechanical and neurocognitive function of a subject includes the step 1511 of using the third video display 1311 of the third computer 1310 to present to the subject a plurality of items to be analyzed by the subject. The items presented to the subject are intermixed with other of the items being tested for recognition. The method 1510 for both assessing cognitive function in a subject and testing neuro-mechanical and neurocognitive function of the subject also includes the step 1512 of having the subject activate the third response sensor 1312 after the subject has looked at the third display 1311 and has recognized the presented items from memory. The subject is tested to determine if the subject recognizes each of the items as meeting specific criteria which the subject does by activating the third response sensor 1312. The method 1510 for both assessing cognitive function in the subject and testing neuro-mechanical and neurocognitive function of a subject further includes the step 1513 of using the third microprocessor 1313 to determine the subject's accuracy and his response speed to each of the recognized items. The response speed for each of the recognized items is the time required between when the subject is shown an item and when the subject correctly responds that the subject recognizes the item. The method 1510 for both assessing cognitive function in a subject and testing neuro-mechanical and neurocognitive function of the subject still further includes the step 1514 of using the third microprocessor 1313 to analyze a plurality of the response speeds for the recognized items in order to create a report of the subject's accuracy and response speed and the step 1515 of using the third microprocessor 1313 to send to the subject the report of the subject's accuracy and response speed. The method 1510 for both assessing cognitive function in a subject and testing neuro-mechanical and neurocognitive function of the subject also further includes the step 1516 of using the third microprocessor 1313 to request compensation from the subject for an analysis of the report of the subject's accuracy and response speed, the step 1517 of using the third microprocessor 1313 to receive the compensation from the subject which the subject provides, the step 1518 of using the third microprocessor 1313 to request that the subject provide personal information upon receipt of the compensation, the step 1519 of using the third microprocessor 1313 to receive the personal information which the subject provides, the step 1520 of using the third microprocessor 1313 to analyze the subject's accuracy and response speed to each of the recognized items and the step 1521 of using the third microprocessor 1313 to report to the subject an evaluation of the subject's performance of cognitive function. The method 1510 for both assessing cognitive function in the subject and testing neuro-mechanical and neurocognitive function of a subject still further includes the step 1522 of using the third microprocessor 1313 to render a test including at least one test module for displaying on the third video display 1312 the test to the subject, the step 1523 of using the third microprocessor 1313 to generate a request for subject's input indicative of subject's response to the displayed test, the step 1524 of using the third microprocessor 1313 to receive the subject's input indicative of the subject's response to the test, the step 1525 of using the third microprocessor 1313 to compute at least one subject score as a function of the received subject's input and the step 1526 of using the third microprocessor 1313 to compare the subject's score to the subject's baseline score. The subject's baseline score includes a mean score and a standard deviation computed from a plurality of subject's scores obtained from previously completed tests by the subject. The method 1510 for both assessing cognitive function in a subject and testing neuro-mechanical and neurocognitive function of the subject still also further includes the step 1527 of using the third microprocessor 1313 to provide at least one of the subject's scores and the step 1528 of using the third microprocessor 1313 to provide the score comparison and to display the results to the subject on the third video display 1311 of the third computer 1310.

From the foregoing it can be seen that a methods for assessing cognitive function in a subject have been described.

Accordingly it is intended that the foregoing disclosure and showing made in the drawing shall be considered only as an illustration of the principle of the present invention.

1. (canceled)

2. A method for assessing cognitive function in a subject according to claim 9 wherein said method for assessing cognitive function in a subject further includes the steps of:
(a) using the microprocessor to request compensation from the subject for an analysis of the report of accuracy and response speed;
(b) using the microprocessor to receive said compensation from the subject which the subject provides;
(c) using the microprocessor to request that the subject provide personal information upon receipt of said compensation;
(d) using the microprocessor to receive said personal information which the subject provides;
(e) using the microprocessor to analyze the subject's accuracy and response speed to each of said items as meeting specific criteria; and
(f) using the microprocessor to report to the subject an evaluation of his performance of cognitive function.

3. A system to determine the presence of temporary mental impairment for use with a computer having a display, a response sensor and a microprocessor, said temporary mental impairment determination system comprising:
(a) an aural generator which generates an aural stimulus in the form of a sound to be heard by a subject;
(b) a receiver which receives a vocal response to said aural stimulus from the subject; and
(c) a measuring device which measures said vocal response to determine mental impairment of the subject for the ability to safely operate machinery.

4. A system to determine the presence of temporary mental impairment according to claim 3 wherein said sound is verbal.

5. A system to determine the presence of temporary mental impairment according to claim 3 wherein said sound is non-verbal.

6. A computer-executed method for testing neuro-mechanical and neurocognitive function in a subject for use with a computer having a display, a response sensor, and a microprocessor, said computer-executed method comprising the steps of:
(a) using the microprocessor to render a test including at least one test module for displaying the test to the subject;
(b) using the microprocessor to generate a request for subject's input indicative of subject's response to the displayed test;
(c) using the microprocessor to receive said subject's input indicative of said subject's response to the test;
(d) using the microprocessor to compute at least one subject score as a function of said received subject's input;
(e) using the microprocessor to compare the at least one subject's score to at least one of said subject's baseline including a subject's baseline wherein said subject's baseline includes a mean score and a standard deviation computed from a plurality of subject's scores obtained from previously completed tests by the subject; and
(f) using the microprocessor to provide at least one of said subject's scores and providing the score comparison for displaying to the subject.

7. A method for both assessing cognitive function in a subject and testing neuro-mechanical and neurocognitive function of a subject according to claim 9 wherein said method of testing neuro-mechanical and neurocognitive function of the subject includes the steps of:
(a) using the microprocessor to render a test including at least one test module for displaying on the display the test to the subject;
(b) using the microprocessor to generate a request for subject's input indicative of subject's response to the displayed test;
(c) using the microprocessor to receive said subject's input indicative of said subject's response to the test;
(d) using the microprocessor to compute at least one subject score as a function of said received subject's input;
(e) using the microprocessor to compare the at least one subject's score to at least one of said subject's baseline including a subject's baseline wherein said subject's baseline includes a mean score and a standard deviation computed from a plurality of subject's scores obtained from previously completed tests by the subject; and
(f) using the microprocessor to provide at least one of said subject's scores and providing the score comparison for displaying to the subject.

8. (canceled)

9. A method for assessing cognitive function in a subject according to claim 22 wherein said method for assessing cognitive function in a subject also includes the steps of:
(a) using the microprocessor to determine the subject's accuracy and response speed to each of said items as meeting said specific criterion wherein said response speed for each of said items recognized as meeting said specific criterion is the time required between when the subject is shown an item and when the subject correctly responds that he recognizes said item as meeting said specific criterion;
(b) using the microprocessor to analyze a plurality of the subject's responses and said response speeds for said items meeting said specific criterion in order to create a report of accuracy and response speed; and
(c) using the microprocessor to send to the subject said report of accuracy and response speed.

10. A method for assessing cognitive function in a subject according to claim 22 wherein said items to be analyzed are n1 images wherein each of said n1 images is shown at least once and each of n2 of said n1 images, where n2 is either less than n1 or equal to n1, is shown at least twice and wherein said images are displayed in a predetermined order.

11. A method for assessing cognitive function in a subject according to claim 22 wherein said items to be analyzed are n1 images wherein each of said n1 images is shown at least once, each of n2 of said n1 images, where n2 is either less than n1 or equal to n1, is shown at least twice and each of n3 of said n1 images, where n3 is either less than n2 or equal to n2, is shown at least three times and wherein said images are displayed in a predetermined order.

12. A method for assessing cognitive function in a subject according to claim 22 wherein said items to be analyzed are n1 images wherein each of said n1 images is shown at least once, each of n2 of said n1 images, where n2 is either less than n1 or equal to n1, is shown at least twice, each of n3 of said n1 images, where n3 is either less than n2 or equal to n2, is shown at least three times and each of n4 of said n1 images, where n4 is either less than n3 or equal to n3, is shown at least four times and wherein said images are displayed in a predetermined order.

13. A method for assessing cognitive function in a subject according to claim 22 wherein said items to be analyzed are twenty five images wherein each of said twenty five images is shown at least once, each of fifteen of said twenty five images is shown at least twice and each of ten images of said fifteen images is shown at least three times and wherein said images are displayed in a predetermined order.

14. A method for assessing cognitive function in a subject according to claim 10 wherein after the subject has looked at the display and has recognized one of said presented images as meeting specific criteria the subject activates the response sensor wherein the subject is tested to determine if the subject either recognizes that one of said images that meets said specific criterion or recognizes that one of said images correctly as not meeting said specific criterion by not activating the response sensor.

15. A method for assessing cognitive function in a subject according to claim 11 wherein after the subject has looked at the display and has recognized one of said presented images as meeting specific criteria the subject activates the response sensor wherein the subject is tested to determine if the subject either recognizes that one of said images that meets said specific criterion or recognizes that one of said images correctly as not meeting said specific criterion by not activating the response sensor.

16. A method for assessing cognitive function in a subject according to claim 12 wherein after the subject has looked at the display and has recognized one of said presented images as meeting specific criteria the subject activates the response sensor wherein the subject is tested to determine if the subject either recognizes recognizes that one of said images that meets said specific criterion or recognizes that one of said images correctly as not meeting said specific criterion by not activating the response sensor.

17. A method for assessing cognitive function in a subject according to claim 13 wherein after the subject has looked at the display and has recognized one of said presented images as meeting specific criteria the subject activates the response sensor wherein the subject is tested to determine if the subject either recognizes that one of said images that meets said specific criterion or recognizes that one of said images correctly as not meeting said specific criterion by not activating the response sensor.

18. A method for assessing cognitive function in a subject according to claim 12 wherein the display of the computer presents multiple sets of n1 images whereby multiple groups of presentations of n1, n2, n3, n4, but a new set of pictures, and the subject's analyzed results could be combined to make a more extensive and precise report.

19. (canceled)

20. A method for assessing cognitive function in a subject according to claim 22 wherein said specific criterion is elected from a Markush grouping consisting of said item belonging to a specific category, being in a logical arrangement, being in a mismatch, being a mathematical equation that is either correct such as 1+2=3 or incorrect such as 1+2=4, being a word spelled correctly and being a face of a famous person.

21. A method for assessing cognitive function in a subject according to claim 12 for a plurality of tests wherein the display of the computer presents multiple sets of n1 images whereby multiple groups of presentations of n1, n2, n3, n4, but a new set of images, and the subject's analyzed results could be combined to make a more extensive and precise report and wherein said specific criterion is selected from a Markush grouping consisting of said image being a repeated image, a current image being the same as the one shown two images before the current image, the current image being the same as the one shown three images before the current image, belonging to a specific category, being in a logical arrangement, being in a mismatch, being a mathematical equation that is either correct such as 1+2=3 or incorrect such as 1+2=4, being a word spelled correctly, being a word spelled incorrectly and being a face of a famous person so that said tests can be combined into a composite test assessing a range of functions of the subject thereby allowing inference of function of specific regions of the subject's brain and the creation of a medical report estimating the levels of those functions and comparing those levels to normal values to provide medical suggestions as to the possible presence of deficits.

22. In a testing session a method for assessing cognitive function in a subject, using a computer having a display, a response sensor and a microprocessor, comprising the steps of:
(a) using the display of the computer to present to the subject a plurality of items that have not been seen by the subject previous to the start of the testing session wherein said items presented to the subject are intermixed with repeated items of said presented items; and
(b) having the subject look at the display and, after the subject has looked at the display and has recognized one of said presented items as meeting a specific criterion, activate the response sensor wherein the subject is tested to determine if the subject either recognizes said one of said items as meeting said specific criterion or recognizes one of said items as not meeting said specific criterion by not activating the response sensor.

23. A method for assessing cognitive function in a subject according to claim 22 wherein said specific criterion is that said image is a repeated image.
